(19) United States
(12) Patent Application Publication
(10) Pub. No.: US 2015/0080489 A1
(43) Pub. Date: Mar. 19, 2015

(54) POLYETHERIMIDES, METHODS OF MANUFACTURE, AND ARTICLES FORMED THEREFROM

(71) Applicant: SABIC Innovative Plastics IP B.V., Bergen op Zoom (NL)

(72) Inventors: Matthew L. Kuhlman, Evansville, IN (US); Gurulingamurthy Haralur, Evansville, IN (US)

(21) Appl. No.: 14/026,306

(22) Filed: Sep. 13, 2013

(51) Int. Cl. C08G 73/10; C08L 79/08

(52) U.S. Cl. CPC C08G 73/1071; C08L 79/08
USPC 521/180; 528/170; 524/600; 428/220

(57) ABSTRACT

A polyetherimide composition comprising a polyetherimide manufactured by reaction of an alkali metal salt of a dihydroxy aromatic compound with a bis(halophthalimide) composition comprising, based on the weight of the bis(halophthalimide) composition, at least 15 wt. % of a 3,3′-bis(halophthalimide) of the formula

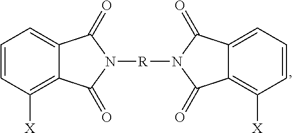

from more than 17 wt. % to less than 85 wt. % of a 4,3′-bis(halophthalimide) of the formula

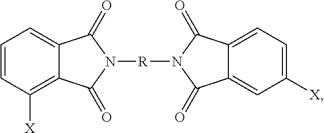

and
from more than 0 wt. % to less than 27 wt. % of a 4,4′-bis(halophthalimide) of the formula

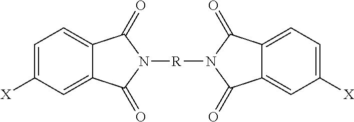

wherein R is para-phenylene.

### BACKGROUND OF THE INVENTION

This disclosure relates to polyetherimides and compositions containing the polyetherimides, as well as their method of manufacture and articles formed from the polyetherimide compositions.

Polyetherimides (“PEIs”) are amorphous, transparent, high performance polymers having a glass transition temperature (“T_{g}”) of greater than 180° C. PEIs further have high strength, heat resistance, and modulus, and broad chemical resistance, and so are widely used in applications as diverse as automotive, telecommunication, aerospace, electrical/electronics, transportation, and healthcare.

Polyetherimides can be manufactured commercially by a “halo-displacement process.” A halogen-substituted anhydride is reacted with a diamine to form a bishalophthalimide. The bishalophthalimide is then reacted with a metal salt of a dihydroxy compound. Despite extensive investigation into the manufacture of polyetherimides produced using the halo-displacement process, there nonetheless remains a need for further improvement. For example, some polyetherimides are currently manufactured using a 95:5 ratio of the 4-isomer to the 3-isomer of the halophthalic anhydride, which yields a product having excellent ductility. Increasing the relative ratio of the 3-isomer can enhance flow and T_{g} of the polyetherimides, but above 50%, the cyclic n=1 byproduct dramatically increases from non-detectable to 1.5 to 15% by weight. These high levels can be detrimental, because the low molecular weight cyclic can act as plasticizer, thereby reducing the T_{g}. The low molecular weight cyclic byproduct also can diffuse out of molded parts at aggressive molding conditions, causing splay and other issues. Three and 4-ClPA can be reacted with para-phenylene diamine (“PPD”) separately to produce 4,4′- or 3,3′-ClPAPI, but when a polymerization of the 4,4′- and 3,3′-ClPAPI is attempted no reaction occurs, apparently due to poor solubility of the 3,3′ or 4,4′-ClPAPI.

There accordingly remains a need in the art for methods for the manufacture of polyetherimides having improved properties, in particular polyetherimides having improved T_{g} and flow, but with reduced levels of byproducts, including halogenated byproducts and cyclic byproducts. It would be a further advantage if such improvements were obtained without significantly adversely affecting other desirable properties of the polyetherimides, for example, one or more of heat deflection temperature, Vicat, and high tensile strength at yield.

### SUMMARY OF THE INVENTION

In an embodiment, a polymer composition comprises a polyetherimide having the formula

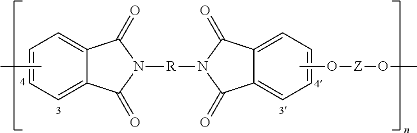

wherein n is greater than 1, each R is para-phenylene, each Z is the same or different, and is an aromatic C₆₋₂₄ monocyclic or polycyclic moiety optionally substituted with 1 to 6 C₁₋₁₈ alkyl groups, 1 to 8 halogen atoms, or a combination thereof, and the divalent bonds between the —O—Z—O— group and the phenyl substituents are in the 3,3′, 3,4′, 4,3′, and 4,4′ positions, the divalent bonds of the of the —O—Z—O— group being made from a bis(halophthalimide) composition comprising, based on the weight of the bis(halophthalimide) composition, at least 15 wt. % of a 3,3′-bis(halophthalimide) of the formula

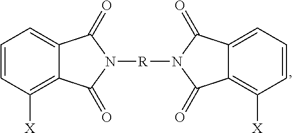

from more than 17 wt. % to less than 85 wt. % of a 3,4′-bis(halophthalimide) of the formula

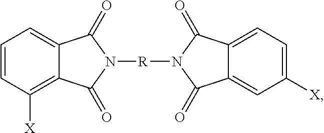

and
from more than 0 to less than 27 wt. % of a 4,4′-bis(halophthalimide) of the formula

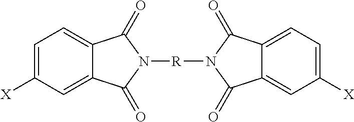

wherein each X is independently fluoro, chloro, bromo, or iodo, and R is para-phenylene; and wherein the T_{g} of the polyetherimide is 230° to 253° C.; the polyetherimide retains 20% to 40% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition, each determined by parallel plate rheometry over at a temperature ranging from 30° to 110° C.; and the polyetherimide has at least a 30% lower shear rate viscosity than that of the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition.

A method for the manufacture of polyetherimide composition, comprising reacting an alkali metal salt of a dihydroxy aromatic compound of the formula

MO—Z—OM

wherein M is an alkali metal and Z is an aromatic C₆₋₂₄ monocyclic or polycyclic moiety optionally substituted with 1 to 6 C₁₋₈ alkyl groups, 1 to 8 halogen atoms, or a combination thereof, with a bis(halophthalimide) composition comprising, based on the weight of the bis(halophthalimide) composition, from more than 30 wt. % to less than 85 wt. % of a 3,3′-bis(halophthalimide) of the formula

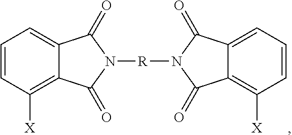

from more than 17 wt. % to less than 85 wt. % of a 4,3′-bis(halophthalimide) of the formula

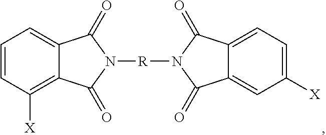

and
from more than 0 to less than 27 wt. % of a 4,4′-bis(halophthalimide) of the formula

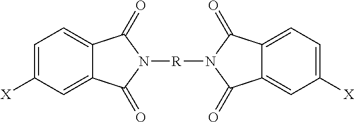

wherein each R is para-phenylene and each X is independently fluoro, chloro, bromo, or iodo, and further wherein the polyetherimide is of the formula

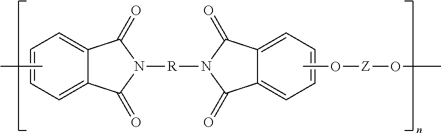

wherein n is greater than 1, each R is para-phenylene, each Z is the same or different, and are as defined above, and the divalent bonds between the —O—Z—O— group and the phenyl substituents are in the 3,3′, 3,4′, 4,3′, and 4,4′ positions; the T_{g} of the polyetherimide is 230° to 253° C.; the polyetherimide retains 20% to 40% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition, each determined by parallel plate rheometry over at a temperature ranging from 30° to 110° C.; and the polyetherimide has at least a 30% lower shear rate viscosity than for the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition.

Compositions comprising the above polyetherimides are disclosed.

A method of manufacture of the above compositions includes melt blending the compositions of the aforementioned polyetherimides.

Articles comprising the above compositions are also disclosed. In an embodiment, the article is selected from a reflector, an optical lens, a fiber optic connector, and an adhesive, specifically an adhesive for adhering a metal to a fluoropolymer such as poly(tetrafluoroethylene). In another embodiment, an article comprises (i) a polytetrafluoroethylene substrate having a first surface, (ii) a metal substrate having a second surface, and (iii) the polymer composition of the invention 1, situated between the polytetrafluoroethylene substrate and the metal substrate.

A method of forming the above articles includes shaping, extruding, blow molding, or injection molding the above compositions to form the article.

The invention is further illustrated by the Drawings, Detailed Description, and Examples.

### BRIEF DESCRIPTION OF THE DRAWINGS

FIG. 1 summarizes the flow properties for Examples 1, 2, 4, and 5.

FIG. 2 summarizes the improved Storage Modulus that was obtained with compositions of the invention as compared to compositions in Comparative Examples.

FIG. 3 summarizes the improved glass transition temperature (T_{g}) exemplified by compositions of the invention as compared to compositions of the Comparative Examples.

FIG. 4 summarizes the substantially lower cyclics that were obtained with compositions of the invention as compared to compositions in the Comparative Examples.

FIG. 5 summarizes the substantially less loss of mass that was observed with the composition of Example 1 as compared to the compositions of Comparative Examples 4 and 5.

### DETAILED DESCRIPTION OF THE INVENTION

The invention is based, in part, on the observation that it is now possible to make a polyetherimide polymer that has a combination of (i) high transition glass (Tg) properties, e.g., a Tg that is greater than 230° C. (ii) an improved viscosity that is substantially lower than viscosity of a polyetherimide made from a ClPAPI component having 3,4-ClPAPI in an amount that is less than 10%, and (iii) a very low cyclic residual content such that articles made from the polymer do not exhibit observable plate-out at molding temperature conditions. The polymer is made from specific isomers mixtures, e.g., mixtures of 3,3′-bis(halophthalimide), 4,3′-bis(halophthalimide), and 4,4′-bis(halophthalimide) isomers.

More particularly, the inventors have discovered that polyetherimides having a surprisingly advantageous combination of properties can be prepared when the ClPAPI is made from a monomer mixture containing a significant portion of 3,4′-ClPAPI, for example a monomer mixture prepared from a mixture containing both 3 and 4-ClPA with PPD. When the ClPAPI is enriched with the 3,4′ isomer the solubility of the other isomers is increased. Without being bound by theory, it appears that this increased solubility allows for polymerization to occur with Na₂BPA; molecular weights from 1,000 to 100,000 amu can be obtained easily. This improved halo-displacement process provides polyetherimides having a reduced content of residuals and byproducts, and in particular a reduced content of the n=1 cyclic byproduct. Furthermore, the polyetherimides can have improved chemical and physical properties, including one or more of high glass transition temperature, stiffness, and viscosity.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations. The endpoints of all ranges directed to the same composition or property are inclusive of the endpoint and independently combinable.

All molecular weights in this application refer to weight average molecular weights unless indicated otherwise and referenced to polystyrene standards. All such mentioned molecular weights are expressed in amu.

The terms “a” and “an” do not denote a limitation of quantity, but rather denote the presence of at least one of the referenced item. As used herein, “combination thereof” is inclusive of one or more of the recited elements, optionally together with a like element not recited. Reference throughout the specification to “one embodiment,” “another embodiment,” “an embodiment,” “some embodiments,” and so forth, means that a particular element (e.g., feature, structure, property, and/or characteristic) described in connection with the embodiment is included in at least one embodiment described herein, and may or may not be present in other embodiments. In addition, it is to be understood that the described element(s) can be combined in any suitable manner in the various embodiments.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The term “alkyl” includes both C₁₋₃₀ branched and straight chain, unsaturated aliphatic hydrocarbon groups having the specified number of carbon atoms, e.g., methyl, ethyl, n-propyl, i-propyl, n-butyl, s-butyl, t-butyl, n-pentyl, s-pentyl, n- and s-hexyl, n- and s-heptyl, and, n- and s-octyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups.

The term “aryl” means an aromatic moiety containing the specified number of carbon atoms, such as to phenyl, tropone, indanyl, or naphthyl. “Alkylene” means a straight or branched chain, saturated, divalent aliphatic hydrocarbon group (e.g., methylene (—CH₂—) or, propylene (—(CH₂)₃—)).

“Cycloalkylene” means a divalent cyclic alkylene group, —CₙH₂ₙ₋ₓ wherein x represents the number of hydrogens replaced by cyclization(s). “Cycloalkenyl” means a monovalent group having one or more rings and one or more carbon-carbon double bond in the ring, wherein all ring members are carbon (e.g., cyclopentyl and cyclohexyl).

The prefix “halo” means a group or compound including one more of a fluoro, chloro, bromo, iodo, and astatino substituent. A combination of different halo groups (e.g., bromo and fluoro) can be present. In an embodiment, only chloro groups are present.

The prefix “hetero” means that the compound or group includes at least one ring that is a heteroatom (e.g., 1, 2, or 3 heteroatom(s)), wherein the heteroatom(s) is each independently N, O, S, Si, or P.

“Substituted” means that the compound or group is substituted with at least one (e.g., 1, 2, 3, or 4) substituent independently selected from a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl)a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁3 arylalkylene, a C₄₋₁₂ heterocycloalkyl, or a C₃₋₁₂ heteroaryl instead of hydrogen, provided that the substituted atom's normal valence is not exceeded.

All ASTM tests are based on the 2003 edition of the Annual Book of ASTM Standards unless otherwise indicated.

The polyetherimides are of formula (1)

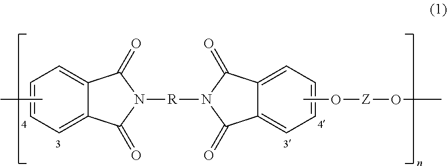

wherein R is para-phenylene, n is greater than 1, for example 10 to 1,000 or more, or more specifically 10 to 500.

The group Z in formula (1) is also a substituted or unsubstituted divalent organic group, and can be an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups derived from a dihydroxy compound of formula (3):

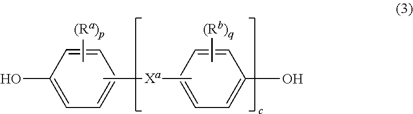

wherein R^{a} and R^{b} each represent a halogen atom or a monovalent hydrocarbon group and can be the same or different; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, O, S, S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formulas (3a)

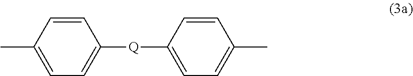

wherein Q is —O—, —S—, —C(O)—, —SO₂—, —SO—, and —C_{y}H_{2y}— and a halogenated derivative thereof (including a perfluoroalkylene group) wherein y is an integer from 1 to 5. In a specific embodiment, Z is derived from bisphenol A wherein Q is 2,2-isopropylidene.

The polyetherimide can be a copolymer, and combinations of polyetherimides can be used. In an embodiment, the polyetherimide optionally comprises additional structural imide units, for example imide units of formula (4)

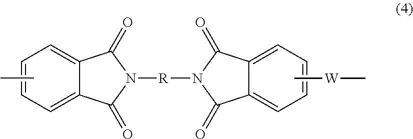

wherein R is as described in formula (1) and W is a linker of formulas (5)

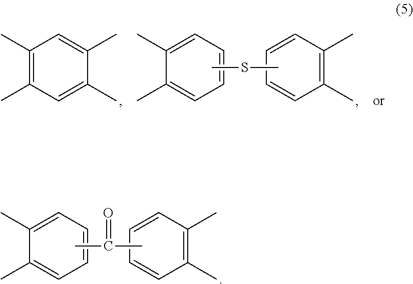

These additional structural imide units can be present in amounts ranging from 0 to 10 mole % of the total number of units, specifically 0 to 5 mole %, more specifically 0 to 2 mole %. In an embodiment no additional imide units are present in the polyetherimide.

The polyetherimides are prepared by the so-called “halo-displacement” or “chloro-displacement” method. In this method, a halophthalic anhydride of formula (6)

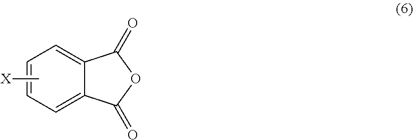

wherein X is a halogen, is condensed with an organic diamine of the formula (7)

H₂N—R—NH₂ (7)

wherein R is as described in formula (1), to form a bis(halophthalimide) of formula (8)

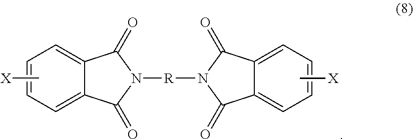

In an embodiment, X is a halogen, specifically fluoro, chloro, bromo, or iodo, more specifically chloro. A combination of different halogens can be used.

In a specific embodiment, diamine (7) is para-phenylene diamine

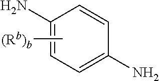

Condensation of halophthalic anhydride (6) and amine (7) (imidization) can be conducted in the absence or presence of a catalyst. Exemplary phase transfer catalysts for imidization include sodium phenyl phosphinate (SPP), acetic acid, hexaethylguanidinium chloride, benzoic acid, phthalic acid, or substituted derivatives thereof. In an embodiment, sodium phenyl phosphinate is used as the imidization catalyst. The catalyst, if used, is present in an amount effective to accelerate the reaction, for example, about 0.1-0.3 wt. % based on the weight of diamine.

The reaction is generally conducted in the presence of a relatively non-polar solvent, preferably with a boiling point above about 100° C., specifically above about 150° C., for example o-dichlorobenzene, dichlorotoluene, 1,2,4-trichlorobenzene, diphenyl sulfone, a monoalkoxybenzene such as anisole, veratrole, diphenylether, or phenetole. Ortho-dichlorobenzene and anisole can be particularly mentioned.

The bis(halophthalimide)s (8) are generally prepared at least 110° C., specifically 150° to 275° C., more specifically 175° to 225° C. At temperatures below 110° C., reaction rates can be too slow for economical operation. Atmospheric or super-atmospheric pressures can be used, for example up to 5 atmospheres, to facilitate the use of high temperatures without causing solvent to be lost by evaporation.

The solvent, diamine (7), and halophthalic anhydride (6) can be combined in amounts such that the total solids content during the reaction to form bis(halophthalimide) (8) does not exceed about 40 wt. %, 25 wt. %, or about 17 wt. %. “Total solids content” expresses the proportion of the reactants as a percentage of the total weight comprising liquids present in the reaction at any given time.

A molar ratio of halophthalic anhydride (6) to diamine (7) of 1.98:1 to 2.04:1, specifically 2:1 is used. While other ratios can be employed, a slight excess of anhydride or diamine can be desirable. A proper stoichiometric balance between halophthalic anhydride (6) and diamine (7) is maintained to prevent undesirable by-products that can limit the molecular weight of the polymer, and/or result in polymers with amine end groups. Accordingly, in an embodiment, imidization proceeds adding diamine (7) to a mixture of halophthalic anhydride (6) and solvent to form a reaction mixture having a targeted initial molar ratio of halophthalic anhydride to diamine; heating the reaction mixture to a temperature of at least 100° C. (optionally in the presence of an imidization catalyst); analyzing the molar ratio of the heated reaction mixture to determine the actual initial molar ratio of halophthalic anhydride (6) to diamine (7); and, if necessary, adding halophthalic anhydride (6) or diamine (7) to the analyzed reaction mixture to adjust the molar ratio of halophthalic anhydride (6) to diamine (7) to 2.01 to 2.3.

To produce a mixture of isomers in the desired range, the 4-halophthalic and 3-halophthalic anhydride are added in relative ratios of for example 75:25 to 25:75; 60:40 to 40:60; or approximately 50:50.

After imidization, the halogen group X of bis(halophthalimide) (8)

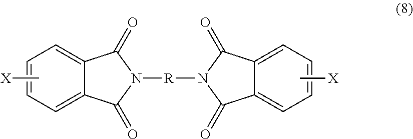

is displaced by reaction with an alkali metal salt of a dihydroxy aromatic compound of formula (9)

MO—Z—OM (9)

wherein M is an alkali metal and Z is as described in formula (1), to provide the polyetherimide of formula (1)

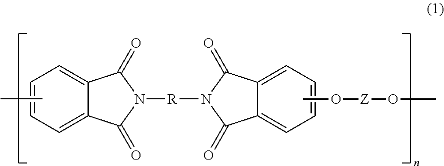

wherein n, R, and Z are as defined above.

The alkali metal M can be any alkali metal, and is typically potassium or sodium. The alkali metal salt can be obtained by reaction of the metal with an aromatic C₆₋₂₄ monocyclic or polycyclic dihydroxy compound optionally substituted with 1 to 6 C₁₋₈ alkyl groups, 1 to 8 halogen atoms, or a combination thereof, for example a compound of formula (3), more specifically a dihydroxy compound corresponding to one of the groups of formulas (3a), and still more specifically a bisphenol compound of formula (10)

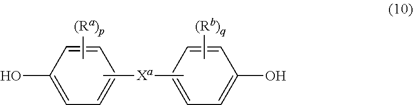

wherein R^{a}, R^{b}, and X^{a} are as described in formula (3). For example, 2,2-bis(4-hydroxyphenyl)propane (“bisphenol A” or “BPA”) can be used.

Polymerization by reaction of bis(halophthalimide) (8) with alkali metal salt (9) can be conducted in the presence or absence of phase transfer catalyst that is substantially stable under the reaction conditions used, in particular temperature. Exemplary phase transfer catalysts for polymerization include hexaalkylguanidinium and α,ω-bis(pentaalkylguanidinium)alkane salts. Both types of salts can be referred to herein as “guanidinium salts.”

Polymerization is generally conducted in the presence of a relatively non-polar solvent, preferably with a boiling point above about 100° C., specifically above about 150° C., for example o-dichlorobenzene, dichlorotoluene, 1,2,4-trichlorobenzene, diphenyl sulfone, a monoalkoxybenzene such as anisole, veratrole, diphenylether, or phenetole. Ortho-dichlorobenzene and anisole can be particularly mentioned. Alternatively, a polar aprotic solvent can be used, illustrative examples of which include dimethylformamide (DMF), dimethylacetamide (DMAc), dimethylsulfoxide (DMSO), and N-methylpyrrolidinone (NMP). A combination comprising at least one of the foregoing solvents can be used.

Polymerization can be conducted at a temperature of at least 110° C., specifically 150° to 275° C., more specifically 175° to 225° C. At temperatures below 110° C., reaction rates can be too slow for economical operation. Atmospheric or super-atmospheric pressures can be used, for example up to 5 atmospheres, to facilitate the use of high temperatures without causing solvent to be lost by evaporation.

In an embodiment, alkali metal salt (9) is added to the organic solvent and the water is removed from the mixture, for example, as its azeotrope. The bis(halophthalimide) (8) is then added and water removed from the mixture, for example, as its azeotrope, followed by addition of a catalyst in a pre-dried solution in organic solvent. Water removal from the system can be accomplished in either batch, semi-continuous or continuous processes using means known in the art such as a distillation column in conjunction with one or more reactors. In an embodiment, a mixture of water and non-polar organic liquid distilling from a reactor is sent to a distillation column where water is taken off overhead and solvent is recycled back into the reactor at a rate to maintain or increase the desired solids concentration. Other methods for water removal include passing the condensed distillate through a drying bed for chemical or physical adsorption of water.

The molar ratio of the bis(halophthalimide) (8) to the alkali metal salt (9) can be about 1.0:0.9 to 0.9:1.0. A solids content of the bis(halophthalimide) (8) in the polymerization can be 15 wt. % to 60 wt. %, based on the total weight of the polymerization mixture.

Thus, a method for the manufacture of the polyetherimides from the bis(halophthalimide) composition comprises reacting, in the presence of a catalytically active amount of a phase transfer catalyst, the alkali metal salt (9) with a bis(halophthalimide) (8). It has been discovered by the inventors hereof that desirable properties of the polyetherimide can be obtained by careful selection of the regioisomers of the bis(halophthalimide)s (8) used to manufacture the polyetherimides. In particular, the bis(halophthalimide)s (8) can be formed from the 3-halophthalic anhydride (6a) and/or the 4-halophthalic anhydride (6b)

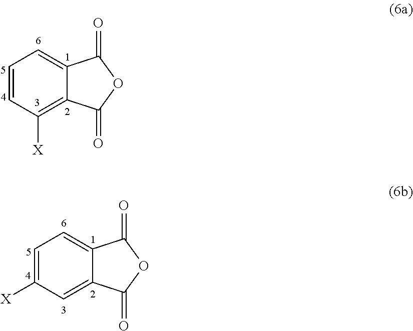

to provide the 3,3′-bis(halophthalimide) (8a), the 3,4′-bis(halophthalimide) (8b), and/or the 4,4′-bis(halophthalimide) (8c).

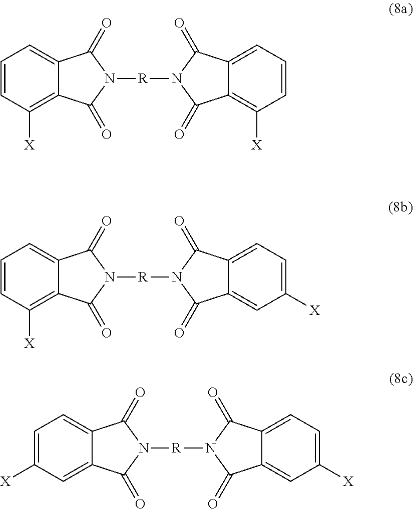

As can be seen from formula (8b), when R is symmetrical (e.g., a 1,3-phenylene or 1,4-phenylene) the 3,4′- and 4,3′ isomers are the same. Reference to the 3,4′ isomer herein and in the claims, specifically includes the 4,3′ isomer irrespective of whether R is symmetrical. In a specific embodiment, a combination of 3-chlorophthalic anhydride (3-ClPA), 4-chlorophthalic anhydride (4-ClPA) and a diamine are reacted to produce the bis(chlorophthalimide).

When the diamine is meta-phenylene diamine, the composition is referred to as (ClPAMI). The ClPAMI product is obtained as a mixture of the 3,3′-bis(chlorophthalimide) (3,3-ClPAMI) (1,3-bis[N-(3-chlorophthalimido)]benzene), the 3,4′-bis(chlorophthalimide) (3,4′-ClPAMI) (1,3-bis[N-(3-chlorophthalimido, 4-chlorophthalimido)]benzene), and the 4,4′-bis(chlorophthalimide) (4,4′-ClPAMI) (1,3-bis[N-(4-chlorophthalimido)]benzene).

When the diamine is para-phenylene diamine, the composition is referred to as (ClPAPI). The ClPAPI product is obtained as a mixture of the 3,3′-bis(chlorophthalimide) (3,3-ClPAPI) (1,4-bis[N-(3-chlorophthalimido)]benzene), the 3,4′-bis(chlorophthalimide) (3,4′-ClPAPI) (1,4-bis[N-(3-chlorophthalimido, 4-chlorophthalimido)]benzene), and the 4,4′-bis(chlorophthalimide) (4,4′-ClPAPI) (1,4-bis[N-(4-chlorophthalimido)]benzene).

Without being bound by theory, it is believed that the solubility of the 3,4′-bis(halophthalimide) (8b), (e.g., the 3,4′-ClPAPI isomer) is about ten-fold greater than the 3,3-bis(halophthalimide) and the 4,4′-bis(halophthalimide) (including the 3,3′- and 4,4′-ClPAPI isomers). Increasing the concentration of the 3,4′-bis(halophthalimide) (8b) allows the weight percent of solids of the reaction to be increased from 30 wt. % to 60 wt. %, when the weight percent of solids is increased from 30 wt. % to 45 wt. %, the cyclic n=1 byproduct decreases from 1.5 wt. % to 0.75 wt. %. Increasing the amount of the 3,4′-bis(halophthalimide) (8b) in the polyetherimide product can adversely affect the modulus and ductility of the polyetherimide product, but this in turn can be remedied by increasing the molecular weight of the polymer. An increase in the molecular weight of the polymer could ordinarily result in processing issues, but such issues are avoided here because the polymer product has improved flow.

Thus, the polyetherimides are manufactured from a bis(halophthalimide) composition, specifically the bis(chlorophthalimide) composition, comprising the 3,3′-bis(halophthalimide) (8a), specifically 3,3′-ClPAPI, in an amount of at least 15 wt. %, specifically 15 wt. % to less than 85 wt. %, more specifically 17 wt. % to 80 wt. %, or 19 wt. % to 75 wt. %, based on the total weight of the bis(halophthalimide) composition. In another embodiment, the bis(halophthalimide) composition comprises 15 wt. % to less than 53 wt. %, specifically 17 wt. % to 51 wt. %, more specifically 19 wt. % to 49 wt. % of 3,3′-bis(halophthalimide) (8a), specifically 3,3′-ClPAPI, based on the weight of the bis(halophthalimide) composition.

The bis(halophthalimide) composition, specifically the bis(chlorophthalimide) composition, also further comprises the 4,3′-bis(halophthalimide) (8b), specifically 3,4′-ClPAPI, in an amount of more than 10 wt. %, specifically more than 10 wt. % to less than 85 wt. %, or more than 17 wt. % to less than 85 wt. %, or 18 wt. % to 84 wt. %, or 19 wt. % to 82 wt. %, or 25 wt. % to 80 wt. %, or 30 wt. % to 78 wt. %, based on the total weight of the bis(halophthalimide) composition. Alternatively, the bis(halophthalimide) composition comprises 50 wt. % to 85 wt. %, or 68 wt. % to 85 wt. % of 4,3′-bis(halophthalimide) (8b), specifically 3,4′-ClPAPI, based on the total weight of the bis(halophthalimide) composition. In another embodiment, the bis(halophthalimide) composition comprises more than 47 wt. % to less than 85 wt. %, or 49 wt. % to 80 wt. %, or 51 wt. % to 75 wt. % of the 4,3′-bis(halophthalimide) of formula (8b), specifically 3,4′-ClPAPI, based on the weight of the bis(halophthalimide) composition.

Also, the bis(halophthalimide) composition, specifically the bis(chlorophthalimide) composition, comprises the 4,4′-bis(halophthalimide) (8c), specifically 4,4′-ClPAPI, in an amount of from more than 0 wt. % to less than 27 wt. %, specifically 1 wt. % to 26 wt. %, or 2 wt. % to 24 wt. %, or 3 wt. % to 20 wt. %, based on the weight of the bis(halophthalimide) composition.

Thus, in a method for the manufacture of the polyetherimides, a first portion of the alkali metal salt of the dihydroxy aromatic compound is reacted with the bis(halophthalimide) composition to form a first polyetherimide having a first molecular weight; and a second portion of the alkali metal salt of the dihydroxy aromatic compound is added to the first polyetherimide to form a second polyetherimide having a second molecular weight higher than the first molecular weight. In another embodiment, a third portion of the alkali metal salt of the dihydroxy aromatic compound is added to the second polyetherimide to form a third polyetherimide having a third molecular weight higher than the second molecular weight. In still another embodiment, a fourth portion of the alkali metal salt of the dihydroxy aromatic compound is added to the third polyetherimide to form a fourth polyetherimide having a fourth molecular weight higher than the third molecular weight. In order to minimize the concentration of cyclic n=1 byproduct, reactants and reaction conditions, in particular 26, 50 and 24 wt. % of 3,3′-ClPAPI, 3,4′-ClPAPI, and 4,4′-ClPAPI respectively, and a salt to ClPAPI ratio of 0.94 to 0.95 are selected to initially produce a polymer product having an Mw of 25,000 to 35,000 amu. The reaction mixture containing this product is then subjected to 1 to 5, specifically 1 to 3, or 1 to 2 corrections by the addition of additional alkali metal salt, in order to produce a polymer having an Mw of 50,000 to 60,000 amu.

The polyetherimides manufactured using the bis(halophthalimide) compositions as described above retain 20% to 40% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition, each determined by parallel plate rheometry over at a temperature ranging from 30° to 110° C.

In addition, the polyetherimide can have at least 30% lower shear rate viscosity than for the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition.

The polyetherimides manufactured using the above-described bis(halophthalimide) composition have the —O—Z—O— groups in the polyetherimide in the 3,3′, 3,4′, 4,3′, and 4,4′ positions in the same or substantially the same ratio as in the bis(halophthalimide) compositions. In an embodiment, the polyetherimide is of formula (1)

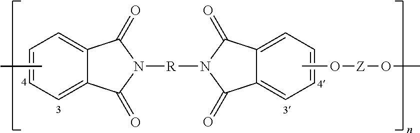

wherein n, R, and Z are as defined above. In addition, based on the total mole percent of the —O—Z—O— groups in the polyetherimide, the polyetherimides have more than 0 to less than 15 mole percent of the —O—Z—O— groups in the 3,3′ position, more than 17 less than 85 mole percent of the —O—Z—O— groups in the 3,4′, and 4′,3 positions, specifically more than 47 wt. % to less than 85 wt. % of the —O—Z—O— groups in the 3,4′, and 4′,3 positions, and from more than 0 to less than 27 mole percent of the divalent bonds of the —O—Z—O— groups in the 4,4′ position. In an embodiment, the polyetherimide has from 15 to less than 85 mol % of the of the —O—Z—O— groups in the 3,3′ position, from more than 47 to less than 85 mol % of the O—Z—O— groups in the 4,3′ and 3,4′ positions, and from more than 0 to less than 27 mol % of the O—Z—O— groups in the 4,4′ position. In another embodiment, based on the total mole percent of the —O—Z—O— groups in the polyetherimide, the polyetherimide has at least 15 mol % the divalent bonds of the —O—Z—O— groups in the 3,3′ position, more than 10 mol % of the —O—Z—O-groups in the 3,4′, and 4′,3 positions, and less than 27 mol % of the —O—Z—O— groups in the 4,4′ position. Other mole percents, reflective of the weight percents in the bis(halophthalimide) compositions disclosed herein, can be used. Of course, these polyetherimides can have any one or more of the properties and characteristics described herein.

The polyetherimides manufactured using the above-described bis(halophthalimide) composition can comprise, based on parts by weight of the polyetherimide, less than 100 parts per million (ppm), specifically less than 80 ppm, more specifically less than 60 ppm each of the 3,3′-bis(halophthalimide), the 4,3′-bis(halophthalimide), and the 4,4′-bis(halophthalimide). In addition, the polyetherimide can comprise, based on parts of the polyetherimide, less than 100 ppm, specifically less than 80 ppm, more specifically less than 60 ppm of a halo(bisphthalimide) of the formula

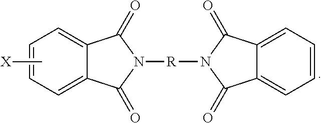

In addition, the polyetherimide can comprise, based on parts of the polyetherimide, less than 100 ppm, specifically less than 80 ppm, more specifically less than 60 ppm of a bisphthalimide of the formula

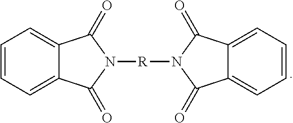

Also, the polyetherimide can comprise, based on parts of the polyetherimide, less than 200 ppm, specifically less than 180 ppm, more specifically less than 160 ppm of a total of the 3,3′-bis(halophthalimide), the 4,3′-bis(halophthalimide), the 4,4′-bis(halophthalimide), and the halo(bisphthalimide).

In a further advantageous feature, the polyetherimides have reduced levels of the cyclic n=1 byproduct arising from the intramolecular reaction of the alkali metal salt (9) and the bis(halophthalimide)s (8). In an embodiment, the polyetherimides manufactured as described above comprises, based on parts of the polyetherimide, less than 1.5 wt. %, specifically less than 1.1 wt. %, more specifically less than 0.6 wt. % of the cyclic n=1 adduct of the alkali metal salt (9) and the bis(halophthalimide) (8), specifically the 3,3′ bis(halophthalimide). In a specific embodiment wherein X is Cl, the polyetherimide comprises, based on parts of the polyetherimide, less than 1.5 wt. %, specifically less than 1.1 wt. %, more specifically less than 0.6 wt. % of the cyclic n=1 adduct of the alkali metal salt (9) and the bis(chlorophthalimide) (8).

The polyetherimides can have a weight average molecular weight (Mw) of 5,000 to 100,000 grams per mole (g/mole) as measured by gel permeation chromatography (GPC). In some embodiments, the Mw can be 10,000 to 80,000. The molecular weights as used herein refer to the polystyrene standard weight averaged molecular weight (Mw).

The polyetherimides can have a glass transition temperature of greater than 180° C., specifically of 200° to 315° C., as measured using differential scanning calorimetry (DSC) per ASTM test D3418. In an embodiment, the polyetherimide has a glass transition temperature of 230° to 253° C.

The compositions can further optionally comprise a reinforcing filler, for example, a flat, plate-like, and/or fibrous filler. Typically, the flat, plate-like filler has a length and width at least ten times greater than its thickness, where the thickness is from 1 to 1000 micrometers (μm). Exemplary reinforcing fillers of this type include glass flakes, mica, flaked silicon carbide, aluminum diboride, aluminum flakes, and steel flakes; wollastonite comprising surface-treated wollastonite, calcium carbonate comprising chalk, limestone, marble and synthetic, precipitated calcium carbonates, generally in the form of a ground particulates; talc, comprising fibrous, modular, needle shaped, and lamellar talc; kaolin, comprising hard, soft, calcined kaolin, and kaolin comprising various coatings known in the art to facilitate compatibility with the polymeric matrix resin; mica; and feldspar.

Exemplary reinforcing fillers also include fibrous fillers such as short inorganic fibers, natural mineral fibrous fillers, single crystal fibers, glass fibers, ceramic fibers, and organic reinforcing fibrous fillers. Short inorganic fibers include, borosilicate glass, carbon fibers, and those derived from blends comprising at least one of aluminum silicates, aluminum oxides, magnesium oxides, and calcium sulfate hemihydrate. Single crystal fibers or “whiskers” include silicon carbide, alumina, boron carbide, iron, nickel, and copper single crystal fibers. Glass fibers, comprising glass fibers such as E, ECR, S, and NE glasses and quartz, and the like can also be used.

Such reinforcing fillers can be provided in the form of monofilament or multifilament fibers and can be used either alone or in combination with other types of fiber, through, for example, co-weaving or core/sheath, side-by-side, orange-type or matrix and fibril constructions, or by other methods known to one skilled in the art of fiber manufacture. Typical cowoven structures include glass fiber-carbon fiber, carbon fiber-aromatic polyimide (aramid) fiber, and aromatic polyimide fiber-glass fiber. Fibrous fillers can be supplied in the form of, for example, rovings, woven fibrous reinforcements, such as 0-90 degree fabrics, non-woven fibrous reinforcements such as continuous strand mat, chopped strand mat, tissues, papers and felts and 3-dimensionally woven reinforcements, performs and braids.

The reinforcing fibers can have a diameter of 5 to 25 micrometers, specifically diameters of 9 to 15 micrometers. In preparing molding compositions it is convenient to use reinforcing fibers such as fiberglass in the form of chopped strands of from 3 millimeters to 15 millimeters long. In articles molded from these compositions, on the other hand, shorter lengths will typically be encountered because during compounding considerable fragmentation can occur. Combinations of rigid fibrous fillers with flat, plate-like fillers can be used, for example, to reduce warp of a molded article.

In some applications it can be desirable to treat the surface of the filler with a chemical coupling agent to improve adhesion to a thermoplastic resin in the composition. Examples of useful coupling agents are alkoxy silanes and alkoxy zirconates Amino, epoxy, amide, or thio functional alkoxy silanes are especially useful. Fiber coatings with high thermal stability are preferred to prevent decomposition of the coating, which could result in foaming or gas generation during processing at the high melt temperatures required to form the compositions into molded parts.

The amount of reinforcing filler used in the polyetherimide compositions can vary widely, and is the amount effective to provide the desired physical properties and flame resistance. In some instances, the reinforcing filler is present in an amount from more than 10 wt. % to 60 wt. %, more specifically 15 wt. % to 40 wt. %, and even more specifically 20 wt. % to 35 wt. %, each based on the total weight of the composition.

The polyetherimide compositions can optionally further comprise one or more other types of particulate fillers. Exemplary particulate fillers include silica powder, such as fused silica and crystalline silica; boron-nitride powder and boron-silicate powders; alumina, and magnesium oxide (or magnesia); silicate spheres; flue dust; cenospheres; aluminosilicate (armospheres); natural silica sand; quartz; quartzite; perlite; tripoli; diatomaceous earth; synthetic silica; and combinations thereof. All of the above fillers can be surface treated with silanes to improve adhesion and dispersion with the polymeric matrix resin. When present, the amount of additional particulate filler in the polyetherimide composition can vary widely, and is the amount effective to provide the desired physical properties and flame resistance. In some instances, the particulate filler is present in an amount from 1 wt. % to 80 wt. %, specifically 5 wt. % to 30 wt. %, more specifically 5 wt. % to 20 wt. %, each based on the total weight of the composition.

The polyetherimide compositions can include various additives ordinarily incorporated into polymer compositions of this type, with the proviso that any additive is selected so as to not significantly adversely affect the desired properties of the composition. Exemplary additives include catalysts (for example, to facilitate reaction between an impact modifier and the polyester), antioxidants, thermal stabilizers, light stabilizers, ultraviolet light (UV) absorbing additives, quenchers, plasticizers, lubricants, mold release agents, antistatic agents, visual effect additives such as dyes, pigments, and light effect additives, flame resistances, anti-drip agents, and radiation stabilizers. Combinations of additives can be used. The foregoing additives (except any fillers) are generally present in an amount from 0.005 wt. % to 20 wt. %, specifically 0.01 wt. % to 10 wt. %, based on the total weight of the composition.

Suitable antioxidants can be compounds such as phosphites, phosphonites and hindered phenols or mixtures thereof. Phosphorus-containing stabilizers comprising triaryl phosphites and aryl phosphonates are useful additives. Difunctional phosphorus containing compounds can also be unseeded. Preferred stabilizers can have a molecular weight greater than or equal to 300. Some exemplary compounds are tris-di-tert-butylphenyl phosphite available from Ciba Chemical Co. as IRGAPHOS 168 and bis(2,4-dicumylphenyl) pentaerythritol diphosphite available commercially from Dover Chemical Co. as DOVERPHOS S-9228.

Examples of phosphites and phosphonites include: triphenyl phosphite, diphenyl alkyl phosphites, phenyl dialkyl phosphites, tris(nonylphenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,6-di-tert-butyl-4-methylphenyl)-pentaerythritol diphosphite, diisodecyloxy pentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol tri-phosphite, tetrakis(2,4-di-tert-butyl-phenyl) 4,4′-biphenylene diphosphonite, bis(2,4-di-tert-butyl-6-methylphenyl)methyl phosphite, bis(2,4-di-tert-butyl-6-methylphenyl)ethyl phosphite, 2,2′,2″-nitrilo[triethyl tris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite and 5-butyl-5-ethyl-2-(2,4,6-tri-tert-butylphenoxy)-1,3,2-dioxaphosphirane.

Combinations comprising more than one organophosphorous compound are contemplated. When used in combination the organophosphorous compounds can be of the same type or different types. For example, a combination can comprise two phosphites or a combination can comprise a phosphite and a phosphonite. In some embodiments, phosphorus-containing stabilizers with a molecular weight greater than or equal to 300 are useful. Phosphorus-containing stabilizers, for example an aryl phosphite, may be present in the composition in an amount from 0.005 wt. % to 3 wt. %, specifically 0.01 wt. % to 1.0 wt. %, based on total weight of the composition.

Hindered phenols can also be used as antioxidants, for example alkylated monophenols, and alkylated bisphenols or polyphenols. Exemplary alkylated monophenols include 2,6-di-tert-butyl-4-methylphenol; 2-tert-butyl-4,6-dimethylphenol; 2,6-di-tert-butyl-4-ethylphenol; 2,6-di-tert-butyl-4-n-butylphenol; 2,6-di-tert-butyl-4-isobutylphenol; 2,6-dicyclopentyl-4-methylphenol; 2-(alpha-methylcyclohexyl)-4,6-dimethylphenol; 2,6-dioctadecyl-4-methylphenol; 2,4,6-tricyclohexylphenol; 2,6-di-tert-butyl-4-methoxymethylphenol; nonyl phenols which are linear or branched in the side chains, for example, 2,6-di-nonyl-4-methylphenol; 2,4-dimethyl-6-(1′-methylundec-1′-yl)phenol; 2,4-dimethyl-6-(1′-methylheptadec-1′-yl)phenol; 2,4-dimethyl-6-(1′-methyltridec-1′-yl)phenol and mixtures thereof. Exemplary alkylidene bisphenols include 2,2′-methylenebis(6-tert-butyl-4-methylphenol), 2,2′-methylenebis(6-tert-butyl-4-ethylphenol), 2,2′-methylenebis[4-methyl-6-(alpha-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(alpha-methylbenzyl)-4-nonylphenol], 2,2′-methylenebis[6-(alpha,alpha-dimethylbenzyl)-4-nonylphenol], 4,4′-methylenebis-(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis-(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra-(5-tert-butyl-4-hydroxy-2-methylphenyl)pentane and mixtures thereof.

The hindered phenol compound can have a molecular weight of greater than or equal to 300 g/mole. The high molecular weight can help retain the hindered phenol moiety in the polymer melt at high processing temperatures, for example greater than or equal to 300° C. Hindered phenol stabilizers, are usually present in the composition in an amount from 0.005 wt. % to 2 wt. %, specifically 0.01 wt. % to 1.0 wt. %, based on total weight of the composition.

Examples of mold release agents include both aliphatic and aromatic carboxylic acids and their alkyl esters, for example, stearic acid, behenic acid, pentaerythritol tetrastearate, glycerin tristearate, and ethylene glycol distearate. Polyolefins such as high-density polyethylene, linear low-density polyethylene, low-density polyethylene and similar polyolefin homopolymers and copolymers can also be used a mold release agents. Mold release agents are typically present in the composition at 0.05 wt. % to 10 wt. %, based on total weight of the composition, specifically 0.1 wt. % to 5 wt. %. Preferred mold release agents will have high molecular weight, typically greater than 300, to prevent loss of the release agent from the molten polymer mixture during melt processing.

In particular, an optional polyolefin can be added to modify the chemical resistance characteristics and mold release characteristics of the composition. Homopolymers such as polyethylene, polypropylene, polybutene can be used either separately or in combination. Polyethylene can be added as high-density polyethylene (HDPE), low-density polyethylene (LDPE) or branched polyethylene. Polyolefins can also be used in copolymeric form with compounds containing carbonic acid radicals such as maleic acid or citric acid or their anhydrides, acid compounds containing acrylic acid radicals such as acrylic acid ester, and the like, as well as combinations comprising at least one of the foregoing. When present, the polyolefin, in particular HDPET, is used in an amount from more than 0 wt. % to 10 wt. %, specifically 0.1 wt. % to 8 wt. %, more specifically from 0.5 wt. % to 5 wt. %, all based on the total weight of the composition.

In some embodiments, the compositions can further include at least one additional polymer. Examples of such additional polymers include and are not limited to PPSU (polyphenylene sulfone), polyetherimides, PSU (polysulfone), PPET (polyphenylene ether), PFA (perfluoroalkoxy alkane), MFA (co-polymer of TFE tetrafluoroethylene and PFVE perfluorinated vinyl ether), FEP (fluorinated ethylene propylene polymers), PPS (poly(phenylene sulfide), PTFE (polytetrafluoroethylene), PA (polyamide), PBI (polybenzimidizole) and PAI (poly(amide-imide)), poly(ether sulfone), poly(aryl sulfone), polyphenylenes, polybenzoxazoles, polybenzthiazoles, as well as blends and co-polymers thereof. When present, the polymer is used in an amount from more than 0 wt. % to 20 wt. %, specifically 0.1 wt. % to 15 wt. %, more specifically from 0.5 wt. % to 10 wt. %, all based on the total weight of the composition. In an embodiment, no polymer other than the polyetherimide as described herein is present in the composition.

Colorants such as pigment and/or dye additives can also optionally be present. Useful pigments can include, for example, inorganic pigments such as metal oxides and mixed metal oxides such as zinc oxide, titanium dioxide, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or combinations comprising at least one of the foregoing pigments. Pigments are generally used in amount from 0 wt. % to 10 wt. %, specifically 0 wt. % to 5 wt. %, based on the total weight of the composition. In some instances, where improved impact is desired, pigments such as titanium dioxide will have a mean particle size of less than 5 μm.

The composition can also optionally include a fluoropolymer in an effective amount to provide anti-drip or other beneficial properties to the resin composition. In one instance, the fluoropolymer is present in an amount 0.01 wt. % to 5.0 wt. % of the composition. Examples of suitable fluoropolymers and methods for making such fluoropolymers are set forth, for example, in U.S. Pat. Nos. 3,671,487, 3,723,373, and 3,383,092. Suitable fluoropolymers include homopolymers and copolymers that comprise structural units derived from one or more fluorinated alpha-olefin monomers, for example, CF₂═CF₂, CHF═CF₂, CH₂═CF₂ and CH₂═CHF and fluoro propylenes such as, for example, CF₃CF═CF₂, CF₃CF═CHF, CF₃CH═CF₂, CF₃CH═CH₂, CF₃CF═CHF, CHF₂CH═CHF and CF₃CF═CH₂.

Copolymers comprising structural units derived from two or more fluorinated alpha-olefin monomers can also be used, for example poly(tetrafluoroethylene-hexafluoroethylene), as well as copolymers comprising structural units derived from one or more fluorinated monomers and one or more non-fluorinated monoethylenically unsaturated monomers that are copolymerizable with the fluorinated monomers such as poly(tetrafluoroethylene-ethylene-propylene)copolymers. Suitable non-fluorinated monoethylenically unsaturated monomers include for example, alpha-olefin monomers such as ethylene, propylene, butene, acrylate monomers such as, methyl methacrylate, butyl acrylate, and the like, with poly(tetrafluoroethylene)homopolymer (PTFE) preferred.

The fluoropolymer can be pre-blended in some manner with a polymer such as an aromatic polycarbonate or polyetherimide resin. For example, an aqueous dispersion of fluoropolymer and a polycarbonate resin can be steam precipitated to form a fluoropolymer concentrate for use as a drip inhibitor additive in thermoplastic resin compositions, as disclosed, for example, in U.S. Pat. No. 5,521,230. Alternatively, the fluoropolymer can be encapsulated.

In some instances it is desired to have polyetherimide compositions that are essentially free of bromine and chlorine. “Essentially free” of bromine and chlorine means that the composition has less than 3 wt. % of bromine and chlorine, and in other embodiments, less than 1 wt. % bromine and chlorine by weight of the composition. In other embodiments, the composition is halogen free. “Halogen free” is defined as having a halogen content (total amount of fluorine, bromine, chlorine and iodine) of less than or equal to 1,000 parts by weight of halogen per million parts by weight of the total composition (ppm). The amount of halogen can be determined by ordinary chemical analysis such as atomic absorption.

The polyetherimide compositions can be prepared by blending the ingredients under conditions for the formation of an intimate blend. Such conditions often include melt mixing in single or twin screw type extruders, mixing bowl, or similar mixing devices that can apply a shear to the components. Twin-screw extruders are often preferred due to their more intensive mixing capability and self-wiping capability, over single screw extruders. It is often advantageous to apply a vacuum to the blend through at least one vent port in the extruder to remove volatile impurities in the composition. Often it is advantageous to dry the polyetherimide polymers prior to melting. The melt processing is often done at 290° to 370° C. to avoid excessive polymer degradation while still allowing sufficient melting to get an intimate polymer mixture free of any unbelted components. The polymer blend can also be melt filtered using a 40 to 100 micrometer candle or screen filter to remove undesirable black specks or other heterogeneous contaminants.

In an exemplary process, the various components are placed into an extrusion compounder to produce a continuous strand that is cooled and then chopped into pellets. In another procedure, the components are mixed by dry blending, and then fluxed on a mill and comminuted, or extruded and chopped. The composition and any optional components can also be mixed and directly molded, e.g., by injection or transfer molding techniques. Preferably, all of the components are freed from as much water as possible. In addition, compounding is carried out to ensure that the residence time in the machine is short; the temperature is carefully controlled; the friction heat is utilized; and an intimate blend between the components is obtained.

The composition can then be molded in any equipment conventionally used for thermoplastic compositions, such as a Newbury or van Dorn type injection-molding machine with conventional cylinder temperatures, at 320° to 420° C., and conventional mold temperatures at 100° to 170° C.

In a further embodiment, each halo group is a chloro group.

Further, when the bis(halophthalimide) composition comprises from more than 47 wt. % to less than 85 wt. % of the 4,3′-bis(halophthalimide), the polyetherimide comprises, based on parts of the polyetherimide, less than 100 parts per million each of the 3,3′-bis(halophthalimide), the 4,3′-bis(halophthalimide), and the 4,4′-bis(halophthalimide), less than 100 parts per million of a monohalo(bisphthalimide) of the formula

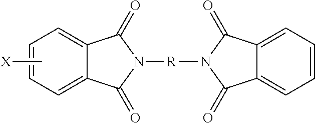

less than 100 parts per million of an unsubstituted bisphthalimide of the formula

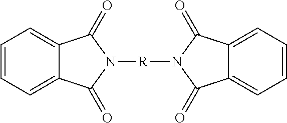

and less than 200 parts per million of a total of the 3,3′-bis(halophthalimide), the 4,3′-bis(halophthalimide), the 4,4′-bis(halophthalimide), and the monohalo(bisphthalimide). In a further embodiment, each halo group is a chloro group.

Also disclosed are articles comprising the above-described polyetherimide compositions. The article can be a sheet, film, multilayer sheet, multilayer film, molded part, extruded profile, coated part, or fiber. Also, the article can be a molded part having a thickness from 0.1 to 100 mm, specifically 1 to 10 mm, more specifically 1 to 5 mm.

The polyetherimide compositions can be formed into articles by any number of methods, for example, shaping, extruding (including profile extrusion), thermoforming, or molding, including injection molding, compression molding, gas assist molding, structural foam molding, and blow molding. In an embodiment, a method of forming an article comprises shaping, extruding, blow molding, or injection molding the composition to form the article. Polyetherimide compositions can also be formed into articles using thermoplastic processes such as film and sheet extrusion, for example melt casting, blown film extrusion and calendaring. Co-extrusion and lamination processes can be used to form composite multi-layer films or sheets.

Examples of applications include: food service, medical, lighting, lenses, sight glasses, windows, enclosures, safety shields, and the like. The high melt flow allows the composition to be molded into intricate parts with complex shapes and/or thin sections and long flow lengths. Examples of other articles include, but are not limited to, cookware, medical devices, trays, plates, handles, helmets, animal cages, electrical connectors, enclosures for electrical equipment, engine parts, automotive engine parts, lighting sockets and reflectors, electric motor parts, power distribution equipment, communication equipment, computers and the like, comprising devices that have molded in snap fit connectors. The polyetherimide compositions can also be made into film and sheet as well as compositions of laminate systems. Other articles include, for example, fibers, sheets, films, multilayer sheets, multilayer films, molded parts, extruded profiles, coated parts and foams: windows, luggage racks, wall panels, chair parts, lighting panels, diffusers, shades, partitions, lenses, skylights, lighting devices, reflectors, ductwork, cable trays, conduits, pipes, cable ties, wire coatings, electrical connectors, air handling devices, ventilators, louvers, insulation, bins, storage containers, doors, hinges, handles, sinks, mirror housing, mirrors, toilet seats, hangers, coat hooks, shelving, ladders, hand rails, steps, carts, trays, cookware, food service equipment, communications equipment and instrument panels.

The compositions are especially useful for articles such as reflectors, e.g., automobile reflectors, an optical lens, a fiber optic connector, and an adhesive. Where the compositions are used as an adhesive, the article comprises a first substrate having a first surface, a second substrate having a second surface, and a layer of an adhesive composition comprising the polyetherimide disposed between the first surface and the second surface. For example, the adhesive can be used to adhere two polymer substrates, two metal substrates, or a metal substrate and a polymer substrate. There is no particular limitation as to the type of metals or polymers in the substrates. In an embodiment, the adhesive is especially useful in an article having a metal substrate and a fluoropolymer substrate (such as polytetrafluoroethylene (PTFE)) substrate, and an adhesive composition comprising the poly(etherimide) disposed between a surface of the metal substrate and a surface of the fluoropolymer substrate. In a specific embodiment, an article comprises (i) a polytetrafluoroethylene substrate having a first surface, (ii) a metal substrate having a second surface, and (iii) the polymer composition of the invention, situated between the polytetrafluoroethylene substrate and the metal substrate. The adhesive layer containing the polymer composition can be in direct contact with the surfaces of the adherends, or an additional layer can be present, for example, a primer.

Without further elaboration, it is believed that one skilled in the art can, using the description herein, utilize the present invention. The following examples are included to provide additional guidance to those skilled in the art of practicing the claims. Accordingly, these examples are not intended to limit the invention in any manner.

### EXAMPLES

Materials used in the Examples are listed in Table 1. Amounts listed in the Examples are in weight percent (wt. %), based on the total weight of the identified composition.

TABLE 1

| Material | Chemical Description | Source |
|---|---|---|
| ClPAPI Mixture 1 | | |
| 25 wt. % 3,3′-ClPAPI | 1,4-bis[N-(3-chlorophthalimido)]benzene; | SABIC |
| 50 wt. % 3,4′-ClPAPI | 1,4-[N-(4-chlorophthalimido)][N-(3-chlorophthalimido)]benzene | |
| 25 wt. % 4,4′-ClPAPI | 1,4-bis[N-(4-chlorophthalimido)]benzene | |
| ClPAPI Mixture 2 | | |
| 57 wt. % 3,3′-ClPAPI | 1,4-bis[N-(3-chlorophthalimido)]benzene | SABIC |
| 37 wt. % 3,4′-ClPAPI | 1,4-[N-(4-chlorophthalimido)][N-(3-chlorophthalimido)]benzene | |
| 6 wt. % 4,4′-ClPAPI | 1,4-bis[N-(4-chlorophthalimido)]benzene | |
| ClPAPI Mixture 3 | | |
| 95 wt. % 3,3′-ClPAPI | 1,4-bis[N-(3-chlorophthalimido)]benzene | SABIC |
| 4 wt. % 3,4′-ClPAPI | 1,4-[N-(4-chlorophthalimido)][N-(3-chlorophthalimido)]benzene | |
| 1 wt. % 4,4′-ClPAPI | 1,4-bis[N-(4-chlorophthalimido)]benzene | |
| ClPAMI Mixture 4 | | |
| 1 wt. % 3,3′-ClPAMI | 1,3-bis[N-(3-chlorophthalimido)]benzene; | SABIC |
| 9 wt. % 3,4′-ClPAMI | 1,3-[N-(4-chlorophthalimido)][N-(3-chlorophthalimido)]benzene | |
| 90 wt. % 4,4′-ClPAMI | 1,3-bis[N-(4-chlorophthalimido)]benzene | |
| ClPAMI Mixture 5 | | |
| 25 wt. % 3,3′-ClPAMI | 1,3-bis[N-(3-chlorophthalimido)]benzene | SABIC |
| 50 wt. % 3,4′-ClPAMI | 1,3-[N-(4-chlorophthalimido)][N-(3-chlorophthalimido)]benzene | |
| 25 wt. % 4,4′-ClPAMI | 1,3-bis[N-(4-chlorophthalimido)]benzene | |
| PEI 1 (Invention) | PEI made from ClPAPI Mixture 1 | SABIC |
| PEI 2 (Invention) | PEI made from ClPAPI Mixture 2 | SABIC |
| PEI 4 (Comparative) | PEI made from ClPAMI Mixture 4 | SABIC |
| PEI 5 (Comparative) | PEI made from ClPAMI Mixture 5 | SABIC |
| pPD | para-phenylene diamine, 1,4-diaminobenzene | Dupont |
| mPD | meta-phenylene diamine, 1,3-diaminobenzene | Dupont |
| 4-ClPA | 4-Chlorophthalic anhydride | SABIC |
| 3-ClPA | 3-Chlorophthalic anhydride | SABIC |
| H₃PO₄ | Phosphoric Acid | Fischer |
| Na₂BPA | Disodium Bisphenol A | SABIC |
| oDCB | Ortho-dichlorobenzene | Fischer |
| HEGCl | Hexaethylguanidinium Chloride | Atul |

### Techniques and Procedures

### Gel Permeation Chromatography Testing Procedure

The GPC samples were prepared by dissolving 5-10 milligrams (mg) of a sample in 10 milliliters (mL) of dichloromethane. Three to five drops of the polymer solution was added to a 10 mL dichloromethane solution with acetic acid (1-2 drops). The sample solution was then filtered and run, and the analysis was performed by referencing the polymer peak to the oDCB peak. The instrument was a Waters 2695 separations module, which was calibrated with polystyrene standards from Aldrich Chemical Company. The cyclics were analyzed by slicing the GPC traces for cyclics n=2 and 3, but the cyclic n=1 was resolved well enough that it could be integrated separately.

### ClPAPI Preparation Procedure: 3,3′-ClPAPI, 3,4′-ClPAPI and 4,4′-ClPAPI Mixture

A 250-mL, three-necked flask equipped with a stopper and a gas valve were charged with 3.0 grams (0.0275 moles) of pPD, 5.052 grams (0.0275 moles) 4-ClPA, 5.052 grams (0.0275 moles) of 3-ClPA, 0.011 grams (0.1 mmoles) of SPP, and 60 grams of oDCB. The flask was then equipped with a stir shaft and bearing, nitrogen adapter, and a Dean Stark trap receiver topped with a reflux condenser. A gentle sweep of nitrogen was established through the head-space of the vessel. The reaction was then heated to 100° C. and then ramped to 200° C. over one hour. The oDCB was removed from the mixture until it reached 20 wt. %-50 wt. % solids (20 grams approximately of oDCB). Note: the random reaction of this mixture of ClPA generates a 1:2:1 ratio of 3,3′-ClPAPI, 3,4′-ClPAPI, and 4,4′-ClPAPI respectively. After 2 to 3 hours, a sample was taken: 30 mg in 20 mL of acetonitrile (sonicated 15 minutes and filtered) and analyzed by HPLC calibrated for monoamine, (monoamine is the mono-imide of halo-phthalic anhydride with a di-amine, such as pPD) 4-ClPA, and pPD. Once the amounts of analytes were known, the appropriate correction was made with either pPD or 4-ClPA. This was repeated until the 3-monoamine, 4-monoamine, 3-ClPA and 4-ClPA were within the spec limit of the reaction, 0.2 mole percent. The reaction was then cooled and kept under a static nitrogen atmosphere.

Isomer mixtures other than the 1:2:1 random distribution illustrated above can be produced according to techniques known in the art, for example by using a similar procedure to prepare the 3,3- and 4,4 ClPAPI isomers separately, and/or by employing different proportions of 3- and 4-ClPA starting materials to produce a product containing a different proportion of the three isomers, then blending the products of differing isomer compositions to produce another desired proportion of isomers in a polymer mixture.

### Polymerization Procedure

Polyetherimides were made as follows. Once the respective mixture of 3,3′, 3,4′, and 4,4′-isomers were made (from the reactions of Mixtures 1, 2, 3, 4, and 5 shown in Table 1, according to the applicable ClPAPI or ClPAMI Preparation Procedure described above), the reaction vessel was then transferred to a dry box where 7.35 grams (0.0270 moles) of the salt Na₂BPA was added. The reaction was then heated to 200° C. with a gentle nitrogen sweep, to remove some oDCB, drying the mixture. oDCB was removed from the mixture until it reached 30-50 weight percent of solids (20-40 grams approximately of oDCB). Once the overheads were dry by Karl Fischer analysis (less than 50 ppm), 71 mg (1 mole %) of HEGCl was charged to the solution; within 30 minutes the solution became brownish and finally a golden solution after 90 minutes. The mixture was sampled after 2 hours to measure Mw, and then Mw analysis was repeated every hour until the reaction plateaued (plateau=3 samples within 300 amu). If the Mw was below 45,000 amu, a correction of Na₂BPA was made. The reaction was then quenched with 134 mg (1 mole % based on polymer) of H₃PO₄ (85% aqueous) concentrated. Once the acid was added, a nitrogen purge was added to remove water (5 minutes). The reaction was heated for another hour. The reaction was then cooled and diluted to 10 wt. % with veratrole or oDCB (approximately 70 mL). The mixture was then filtered on a Buchner funnel using a Whatman 1 micrometer GF (glass filter) disk. The golden solution was then transferred to a 1-liter separatory funnel with an equal volume of acidic water, and vigorously shaken. Once the contents of the separatory funnel split into phases, the golden polymer solution was transferred to a blender with an equal volume of hexane and blended. The mixture was filtered and dried under vacuum at 165° C. for 24 hours.

### Sample Preparation for Property Testing:

Test parts were injection molded on a 180 ton-force (1800 kN) molding machine with a set temperature of approximately 360° to 380° C. The pellets were dried for 3-4 hours at 120° C. in a forced air circulating oven prior to injection molding.

### Testing Procedures

Samples that were Prepared were Tested as Follows.

### Storage Modulus Testing Procedure.

Dynamic Mechanical Analysis (DMA) was performed with the following procedure. The film samples were mounted on the grips and the test was carried out under tensile mode at 1 Hz frequency and with 2° C./minute ramp rate. The storage modulus was recorded as a function of temperature.

### Rheology Testing Procedure

The viscosity was measured using parallel plate rheometry at 340° C., and from 1 rad/s (low shear) to 316 radian/sec (high shear).

### Chemical Resistance Testing Procedure

A sample of polyetherimide film was immersed in methylene chloride and the wt. % loss of film was determined after 1, 3, 7, and 21 days.

### T_{g} Testing Procedure

Glass transition temperature (T_{g}) was measured on a 10 mg sample via differential scanning calorimetry at a heating rate of 20° C./min.

### EXAMPLES 1-5

Purpose: The purpose of Examples 1-5 was to make polyetherimides with 3,4′-ClPAPI-enriched ClPAPI component in an amount of more than 17 wt. % and less than 85 wt. %, evaluate how the different isomers and isomer ratios affect the properties of the materials, and compare the performance properties with polyetherimides made with a 3,4′-ClPAPI-enriched ClPAPI component in an amount of less than 17, as well as with polyetherimides made with 3,4′-ClPAMI component in any ratio.

Accordingly, the Mixtures described in Table 1 were employed in the procedures described above. Polyetherimides were prepared from Mixtures 1, 2, 4, and 5. However, Mixture 3 did not produce a detectable molecular weight build after monitoring the reaction for 48 hours. The resulting polyetherimides are identified as Examples 1 and 2 of the Invention and Comparative Examples 4 and 5 in the tables below.

The polymers prepared were targeted for 55,000 Mw (polystyrene standards were used for calibration), but some were slightly higher and lower Mw. The PDI of the 3-ClPA enriched polymers were higher than the 1000 grade control because of the cyclic n=1, (adduct of one BPA and 3,3′-ClPAMI or 3,3′-ClPAPI). The cyclic n=1 is characteristic of only the 3-ClPA enriched polymer systems due to the high concentration of 3,3′-ClPAMI or 3,3′-ClPAPI.

The polyetherimides were of similar size, as evidenced by the GPC data for Mw, Mn, and PDI, and were tested for T_{g}, Total cyclic content, stiffness, and flow, pursuant to the methods described above and presented in Table 2.

The molecular weight of the polyetherimides were similar in Table 2, as evidenced by the GPC data.

TABLE 2
GPC Analysis of Examples 1, 2, and 4-5*.

| Example | 1 (Invention) | 2 (Invention) | 4 (Comparative) | 5 (Comparative) |
|---|---|---|---|---|
| Mw | 57103 | 56377 | 55000 | 54027 |
| Mn | 24833 | 23602 | 24000 | 19837 |
| Polydispersity Index (PDI) | 2.30 | 2.39 | 2.4 | 2.72 |
| T_{g} (° C.) | 249 | 253 | 219 | 229 |
| Cyclic n = 1, 2, 3 wt. % | 0.8 | 0.6 | 1.1 | 2.4 |
| Chemical Resistance | | | | |
| (wt. % loss) at: | | | | |
| 1 day | 2 | 100 | 100 | 100 |
| 3 days | 4 | 100 | 100 | 100 |
| 7 days | 5 | 100 | 100 | 100 |
| 21 days | 7 | 100 | 100 | 100 |
| Viscosity (Pa), | | | | |
| at Frequency (rad/s) | | | | |
| 1 | 13869 | 12637 | 38160 | 7484 |
| 2 | 12927 | 11811 | 37625 | 7165 |
| 3 | 11869 | 10831 | 36720 | 6949 |
| 6 | 10532 | 9633 | 35373 | 6729 |
| 10 | 8639 | 7972 | 33384 | 6436 |
| 18 | 6317 | 5893 | 30808 | 6015 |
| 32 | 4115 | 3830 | 27591 | 5399 |
| 56 | 2493 | 2166 | 23792 | 4564 |
| Storage Modulus (MPa) | | | | |
| at Temperature (° C.) | | | | |
| 30 | 2428 | 2939 | 1916 | 2159 |
| 40 | 2404 | 2892 | 1888 | 2137 |
| 50 | 2361 | 2832 | 1845 | 2097 |
| 60 | 2334 | 2773 | 1802 | 2059 |
| 70 | 2337 | 2717 | 1762 | 2028 |
| 80 | 2383 | 2662 | 1723 | 2001 |
| 90 | 2492 | 2606 | 1675 | 1971 |
| 100 | 2607 | 2550 | 1610 | 1926 |
| 110 | 2592 | 2493 | 1435 | 1849 |

*(Synthesis from Mixture 3 did not produce polymer; therefore no Example 3 testing).

### Discussion

The results evidence that materials made in accordance to our invention (made from specific isomers mixtures, e.g., mixtures of 3,3′-bis(halophthalimide), 4,3′-bis(halophthalimide), and 4,4′-bis(halophthalimide) isomers) exhibited a unique combination of properties, namely (i) high transition glass temperature that was greater than 230° C. (ii) an improved viscosity that was substantially lower than viscosity of a polyetherimide made from a ClPAPI component having 3,4-ClPAPI in an amount that was less than 10% and (iii) a very low cyclic residual content such that articles made from the polymer did not exhibit observable plate-out at molding temperature conditions.

The results for Example 1 show that when the PEI was made with a mixture containing at least 50 wt. %, 3,4′-ClPAPI, at least 25 wt. % 3,3-ClPAPI, and with a maximum of 25 wt. % of 4,4′-ClPAPI, the resulting PEI had a T_{g} of 249° C. Example 1 had a stiffness of 2,428, which as further discussed below was an increased stiffness: retains at least 20% higher stiffness at a temperature ranging from 30° to 110° C., as compared to that made from a ClPAMI component having 3,4′-ClPAMI in amount that is less 10 wt. %. Further, our PEI exhibits a low shear rate viscosity; whereas a PEI made from a ClPAMI component having 3,4′-ClPAMI in an amount that is less than 10 wt. %, has a high shear rate viscosity that is at least 30% higher than Example 1.

Table 2 shows the improved lower viscosity exhibited by compositions of our invention at the indicated radians/second (from 1 radian/second to 56 radians/second), as is evidenced by subtracting the Comparative Example 4 and from Inventive Examples 1 and 2, then dividing these viscosities of the materials with the viscosities exhibited by the materials in Comparative Example 4, respectively, with the viscosities of the materials used in the inventive Examples 1 and 2. The reduction in viscosity observed by our materials ranged from 45% to approximately 90%. The method for calculating the improved lower viscosity can be summarized by the following formula: {% lower viscosity=100%*(Comparative Example Viscosity−Inventive Example Viscosity)/Comparative Example Viscosity}.

Additionally, the PEI made with a 3,4′-PAPI mixture of at least 50 wt. % 3,4′-ClPAPI, at least 25 wt. % 3,3-ClPAPI, and with a maximum of 25 wt. % of 4,4′-ClPAPI results in a total cyclic wt. % of 0.8, based on the total weight of the polymer (cyclic n=1, 2, and 3). The chemical resistance of the PEI from Example 1 was 87% improved compared to a PEI made from a ClPAMI component having 3,4′-ClPAMI in an amount that is less than 10 wt. % (Example 4).

The results for Example 2 show that when the PEI was made with a mixture containing more than 17 wt. % 3,4′-ClPAPI and at least 57 wt. % 3,3-ClPAPI, the resulting PEI had a T_{g} of 253° C. Example 2 had a stiffness of 2,939 MPa, which as further discussed below was an increased stiffness: retains at least 40% higher stiffness at a temperature ranging from 30° to 110° C., as compared to a PEI made from a ClPAMI component having 3,4′-ClPAMI in an amount that is less than 10 wt. %. Further, the PEI exhibits a low shear rate viscosity; whereas a PEI made from a ClPAMI component having 3,4′-ClPAMI in an amount that is less than 10 wt. % has a high shear rate viscosity that is at least 30% higher than Example 1.

Additionally, the PEI made with a 3,4′-ClPAPI mixture of more than 17 wt. % and at least 57 wt. % 3,3-ClPAMI results in a total cyclic content of 1.3 wt. %, based on the total weight of the polymer (cyclic n=1, 2, and 3).

The results for Comparative Example 4 show that when the PEI was made with a mixture containing less than 10 wt. % 3,4′-ClPAMI and less than 2 wt. % 3,3-ClPAMI the resulting PEI had a T_{g} of 219° C. and a HDT that was at least 218° C. In comparison to the inventions of Examples 1 and 2, the T_{g} is at least 30° C. lower. Comparative Example 4 had a stiffness of 1,916 MPa, which is at least 20% lower in stiffness at a temperature ranging from 30° to 110° C., as compared to the inventions of Examples 1 and 2. Comparative Example 4 exhibits a higher shear rate viscosity; whereas a PEI made from Examples 1 and 2 have a lower shear rate viscosity that is at least 30% lower than Comparative Example 4.

The results for Comparative Example 5 show that when the PEI was made with a mixture containing more than 47 wt. % but less than 85 wt. % 3,4′-ClPAMI and at least 15 wt. % 3,3-ClPAMI, the resulting PEI had a T_{g} of at least 229° C. Comparative Example 5 had a stiffness of 2,159 MPa, which as further discussed below was an increased stiffness: retains at least 10% higher stiffness at a temperature ranging from 30° to 110° C., as compared to one made from a ClPAMI component having 3,4′-ClPAMI in an amount that is less than 10 wt. %. Comparative Example 5 exhibits slightly higher shear rate viscosity; whereas a PEI made from Examples 1 and 2 have a lower shear rate viscosity that is at least 5% lower.

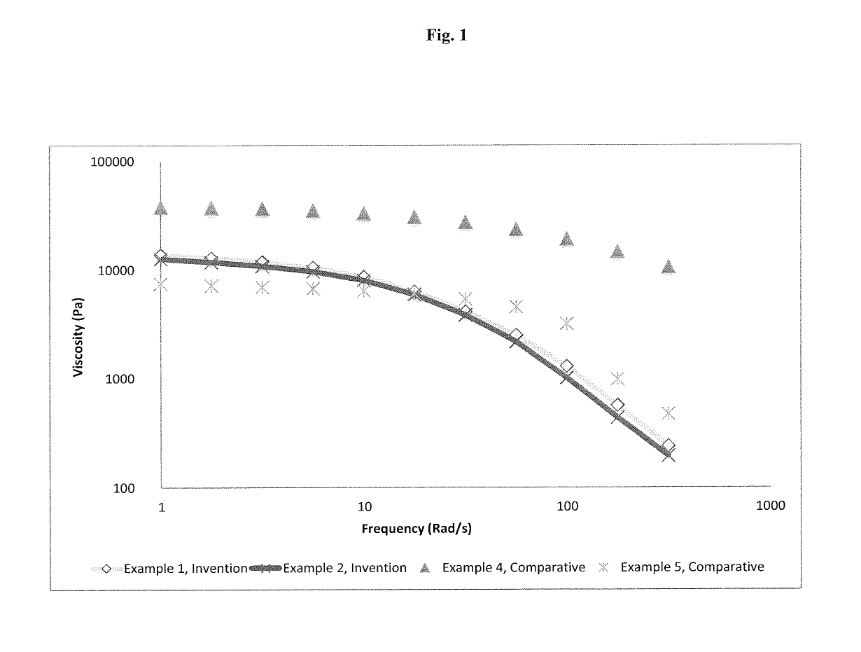

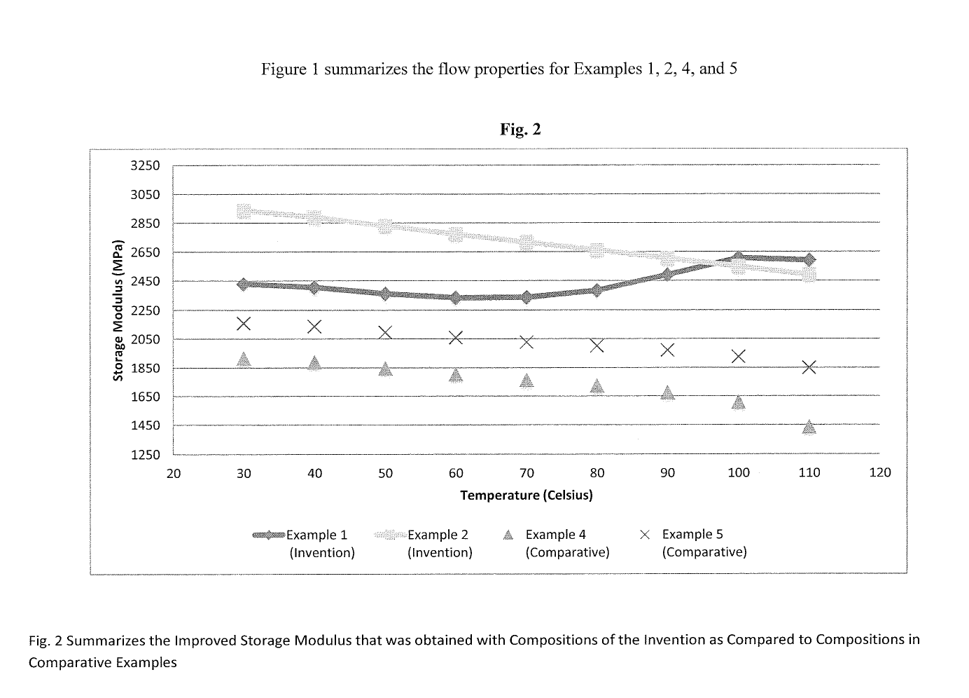

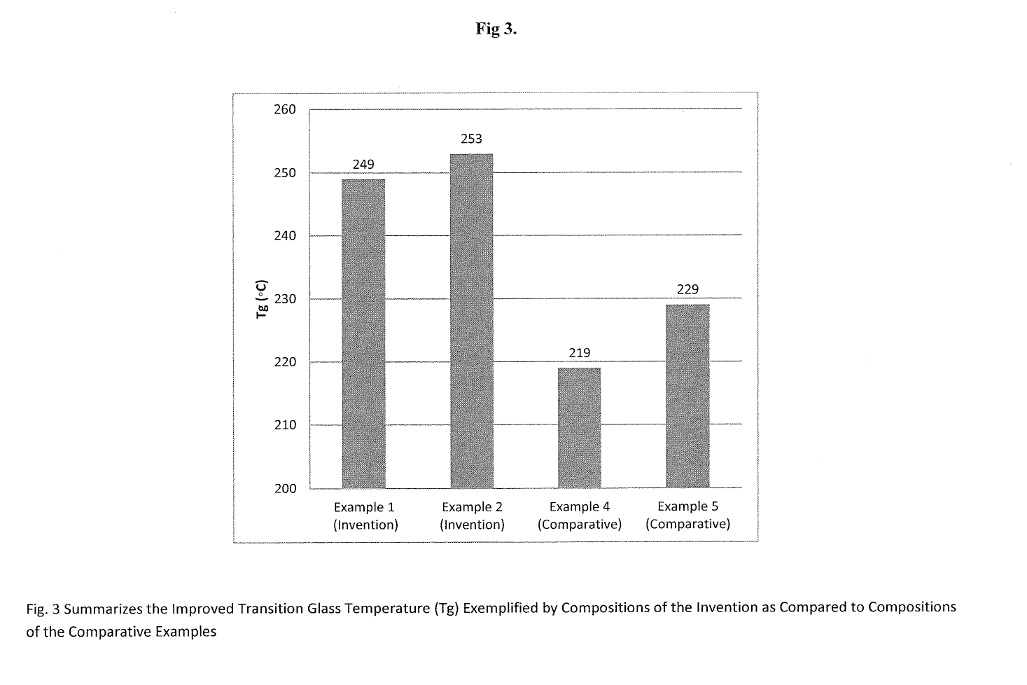

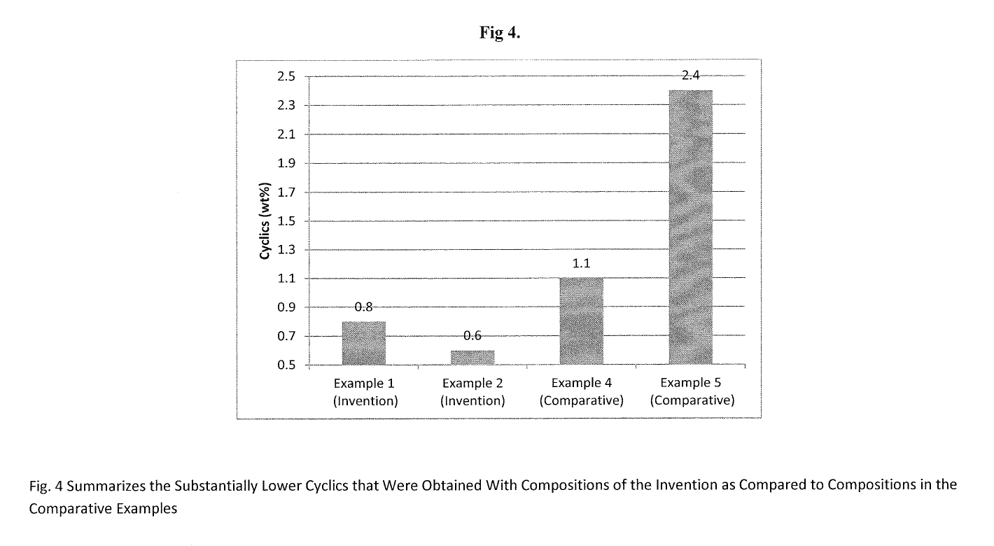

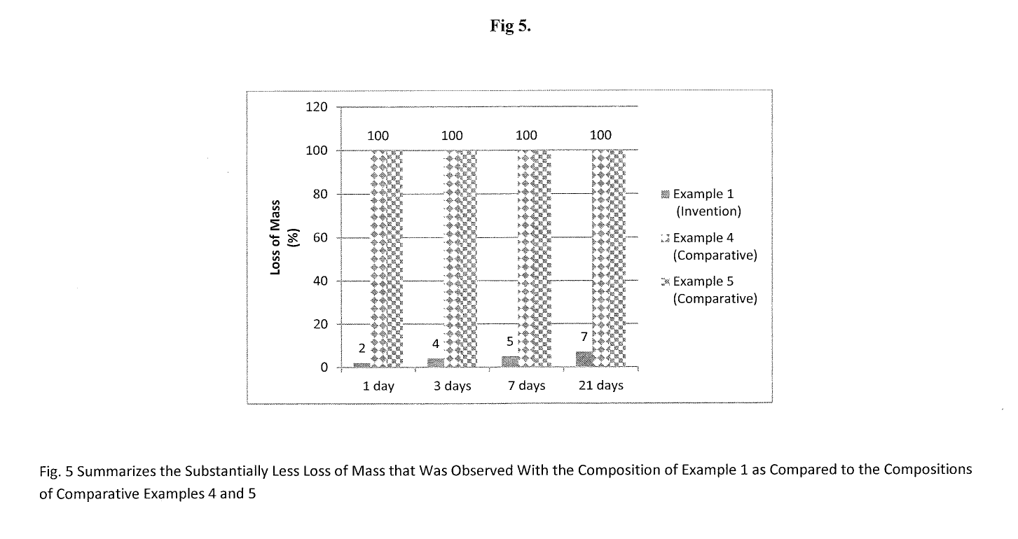

Examples 1 and 2, which represent embodiments of our invention, demonstrated an increased T_{g} of at least 249° C. (FIG. 3), also demonstrated an increased stiffness of at least 20% (FIG. 2), and an increased flow of at least 30% versus the comparative Examples 4 and 5 (FIG. 1). Additionally, Examples 1 and 2, which represent embodiments of our invention, revealed the overall residual level of the cyclic n=1, 2, and 3 to be significantly lower than the comparative examples (FIG. 4) and the chemical resistance of Example 1 to be significantly higher than Examples 2, 4, and 5 (FIG. 5).

All patents and references cited herein are incorporated by reference.

Embodiment 1: A polymer composition comprising a polyetherimide having the formula

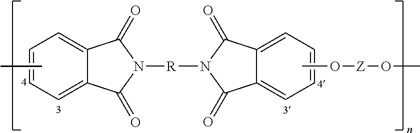

wherein n is greater than 1, each R is para-phenylene, each Z is the same or different, and is an aromatic C₆₋₂₄ monocyclic or polycyclic moiety optionally substituted with 1 to 6 C₁₋₁₈ alkyl groups, 1 to 8 halogen atoms, or a combination thereof, and the divalent bonds between the —O—Z—O— group and the phenyl substituents are in the 3,3′, 3,4′, 4,3′, and 4,4′ positions, the divalent bonds of the of the —O—Z—O— group being made from a bis(halophthalimide) composition comprising, based on the weight of the bis(halophthalimide) composition, at least 15 wt. % of a 3,3′-bis(halophthalimide) of the formula

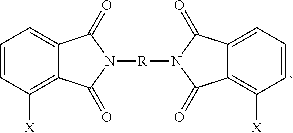

from more than 17 wt. % to less than 85 wt. % of a 3,4′-bis(halophthalimide) of the formula

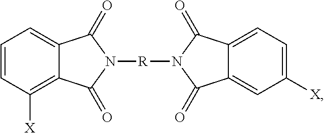

and
from more than 0 wt. % to less than 27 wt. % of a 4,4′-bis(halophthalimide) of the formula

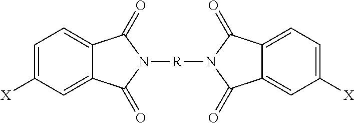

wherein each X is independently fluoro, chloro, bromo, or iodo, and R is para-phenylene; and wherein the T_{g} of the polyetherimide is 230° to 253° C.; the polyetherimide retains 20% to 40% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition, each determined by parallel plate rheometry over at a temperature ranging from 30° to 110° C.; and the polyetherimide has at least a 30% lower shear rate viscosity than that of the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition.

Embodiment 2: The composition of embodiment 1, wherein the bis(halophthalimide) composition comprises, based on the weight of the bis(halophthalimide) composition, from more than 45 wt. % to less than 75 wt. % of the 4,3′-bis(halophthalimide), wherein the composition comprises less than 1 wt. % of total cyclics (n=1, 2, and 3) based on the total weight of the polyetherimide; and the composition has a greater chemical resistance to a halogenated solvent than the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition.

Embodiment 3: The composition of embodiment 2, wherein the halogenated solvent is dichloromethane.

Embodiment 4: The composition of embodiment 1, wherein the bis(halophthalimide) composition comprises, based on the weight of the bis(halophthalimide) composition, from more than 0 wt. % to less than 15 wt. % of the 4,4′-bis(halophthalimide), wherein: the T_{g} of the polyetherimide is at least 30° C. higher than the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition; the polyetherimide retains at least 40% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition; and the polyetherimide has at least a 30% lower shear rate viscosity than for the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition, and each determined by parallel plate rheometry over a temperature ranging from 30° to 110° C.; and wherein each X is independently fluoro, chloro, bromo, or iodo, and R is para-phenylene.

Embodiment 5: The composition of embodiment 1, wherein the bis(halophthalimide) composition comprises, based on the weight of the bis(halophthalimide) composition, from more than 48 wt. % to less than 75 wt. % of the 4,3′-bis(halophthalimide), and less than 26 wt. % of the 4,4′-bis(halophthalimide), wherein the composition comprises less than 1 wt. % of total cyclics (n=1, 2, and 3) based on the total weight of the polyetherimide; and the polyetherimide retains at least 20% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 26 wt. % of 1,3-bis[N-(4-chlorophthalimido)]benzene, each based on the weight of the 1,3-bis[N-(halophthalimido)]benzene composition; and the polyetherimide has at least a 30% lower shear rate viscosity than for the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 26 wt. % of 1,3-bis[N-(4-chlorophthalimido)]benzene, each based on the weight of the 1,3-bis[N-(halophthalimido)]benzene composition.

Embodiment 6: The composition of embodiment 1, wherein the bis(halophthalimide) composition comprises from more than 30 to less than 85 wt. % of the 3,3′-bis(halophthalimide), from more than 48 to less than 75 wt. % of the 4,3′-bis(halophthalimide), and from more than 0 to less than 15 wt. % of the 4,4′-bis(halophthalimide).

Embodiment 7: The composition of embodiment 1, wherein Z is 2,2-(4-phenylene)isopropylidene and the halo group is chloro.

Embodiment 8: The composition of embodiment 1, further comprising an additive selected from impact modifiers, fillers, reinforcing agents, anti-oxidants, heat stabilizers, light stabilizers, ultraviolet light absorbers, plasticizers, lubricants, mold release agents, antistatic agents, colorants, blowing agents, flame retardants, anti-drip agents, and radiation stabilizers, and a combination thereof.

Embodiment 9: The composition of embodiment 1, further comprising an additive selected from an antioxidant, an ultraviolet light absorber, a mold release agent, and a combination thereof.

Embodiment 10: The composition of embodiment 1, wherein the polyetherimide comprises, based on parts of the polyetherimide, less than 100 parts per million each of the 3,3′-bis(halophthalimide), the 4,3′-bis(halophthalimide), and the 4,4′-bis(halophthalimide), less than 100 parts per million of a halo(bisphthalimide) of the formula

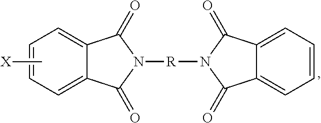

less than 100 parts per million of a bisphthalimide of the formula

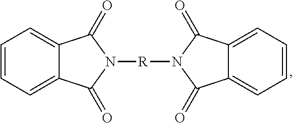

and
less than 200 parts per million of a total of the 3,3′-bis(halophthalimide), the 4,3′-bis(halophthalimide), the 4,4′-bis(halophthalimide), and the halo(bisphthalimide).

Embodiment 11: An article comprising the composition of embodiment 1.

Embodiment 12: The article of embodiment 11, selected from a sheet, film, multilayer sheet, multilayer film, molded part, extruded profile, coated part, and fiber.

Embodiment 13: The article of embodiment 12, wherein the article is a molded part having a thickness from 1 to 5 millimeters.

Embodiment 14: The article of embodiment 11, selected from a camera module, an antenna module, an electrical connector, a hard disc drive bracket, a laptop cover, and a BiTs socket.

Embodiment 15: A method of forming an article, comprising shaping, extruding, blow molding, or molding the composition of embodiment 1 to form the article.

Embodiment 16: The method of embodiment 15, comprising molding the composition to form an article having a thickness from 1 to 5 millimeters.

Embodiment 17: The method of embodiment 16, wherein the article is selected from a camera module, an antenna module, an electrical connector, a hard disc drive bracket, a laptop cover, and a BiTs socket.

Embodiment 18: A method for the manufacture of polyetherimide composition, comprising reacting an alkali metal salt of a dihydroxy aromatic compound of the formula

MO—Z—OM

wherein M is an alkali metal and Z is an aromatic C₆₋₂₄ monocyclic or polycyclic moiety optionally substituted with 1 to 6 C₁₋₈ alkyl groups, 1 to 8 halogen atoms, or a combination thereof, with a bis(halophthalimide) composition comprising, based on the weight of the bis(halophthalimide) composition, from more than 30 wt. % to less than 85 wt. % of a 3,3′-bis(halophthalimide) of the formula

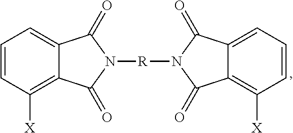

from more than 17 wt. % to less than 85 wt. % of a 4,3′-bis(halophthalimide) of the formula

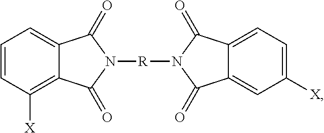

and
from more than 0 wt. % to less than 27 wt. % of a 4,4′-bis(halophthalimide) of the formula

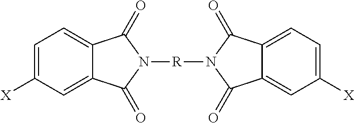

wherein each R is para-phenylene and each X is independently fluoro, chloro, bromo, or iodo, and
further wherein the polyetherimide is of the formula

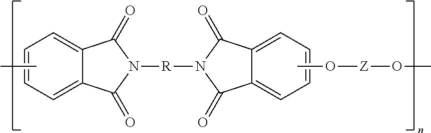

wherein n is greater than 1, each R is para-phenylene, each Z is the same or different, and are as defined above, and the divalent bonds between the —O—Z—O— group and the phenyl substituents are in the 3,3′, 3,4′, 4,3′, and 4,4′ positions; the T_{g} of the polyetherimide is 230° to 253° C., the polyetherimide retains 20% to 40% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition, each determined by parallel plate rheometry over at a temperature ranging from 30° to 110° C.; and the polyetherimide has at least a 30% lower shear rate viscosity than for the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition.

Embodiment 19: The method of embodiment 18, wherein the bis(halophthalimide) composition comprises, based on the weight of the bis(halophthalimide) composition, from more than 45 wt. % to less than 75 wt. % of the 4,3′-bis(halophthalimide), wherein the composition comprises less than 1 wt. % of total cyclics (n=1, 2, and 3) based on the total weight of the polyetherimide; and the composition has a greater chemical resistance to a halogenated solvent than the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition.

Embodiment 20: The method of embodiment 19, wherein the halogenated solvent is dichloromethane.

Embodiment 21: The method of embodiment 18, wherein the bis(halophthalimide) composition comprises, based on the weight of the bis(halophthalimide) composition, from more than 0 wt. % to less than 15 wt. % of the 4,4′-bis(halophthalimide, wherein the T_{g} of the polyetherimide is at least 30° C. higher than the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition; the polyetherimide retains at least 40% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition; and the polyetherimide has at least a 30% low shear rate viscosity than for the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition, and each determined by parallel plate rheometry at a temperature ranging from 30° to 110° C.; and wherein each X is independently fluoro, chloro, bromo, or iodo, and R is para-phenylene.

Embodiment 22: The method of embodiment 18, wherein the bis(halophthalimide) composition comprises, based on the weight of the bis(halophthalimide) composition, from more than 48 wt. % to less than 75 wt. % of the 4,3′-bis(halophthalimide), and less than 26 wt. % of the 4,4′-bis(halophthalimide), wherein the composition comprises less than 1 wt. % of total cyclics (n=1, 2, and 3) based on the total weight of the polyetherimide; and the polyetherimide retains at least 20% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 26 wt. % of 1,3-bis[N-(4-chlorophthalimido)]benzene, each based on the weight of the 1,3-bis[N-(halophthalimido)]benzene composition; and the polyetherimide has a 30% low shear rate viscosity than for the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition.

Embodiment 23: The method of embodiment 18, wherein the bis(halophthalimide) composition comprises from more than 30 wt. % to less than 85 wt. % of the 3,3′-bis(halophthalimide), from more than 48 wt. % to less than 75 wt. % of the 4,3′-bis(halophthalimide), and from more than 0 wt. % to less than 15 wt. % of the 4,4′-bis(halophthalimide).

Embodiment 24: The method of embodiment 18, wherein Z is 2,244-phenylene)isopropylidene and the halo group is chloro.

Embodiment 25: The method of embodiment 18, further comprising adding an additive to the composition, wherein the additive is selected from impact modifiers, fillers, reinforcing agents, anti-oxidants, heat stabilizers, light stabilizers, ultraviolet light absorbers, plasticizers, lubricants, mold release agents, antistatic agents, colorants, blowing agents, flame retardants, anti-drip agents, and radiation stabilizers, and a combination thereof.

Embodiment 26: The method of embodiment 18, further comprising adding an additive to the composition, wherein the additive is selected from an antioxidant, an ultraviolet light absorber, a mold release agent, and a combination thereof.

Embodiment 27: The method of embodiment 18, wherein the polyetherimide comprises, based on parts of the polyetherimide, less than 100 parts per million each of the 3,3′-bis(halophthalimide), the 4,3′-bis(halophthalimide), and the 4,4′-bis(halophthalimide), less than 100 parts per million of a halo(bisphthalimide) of the formula

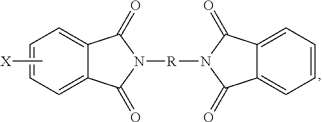

less than 100 parts per million of a bisphthalimide of the formula

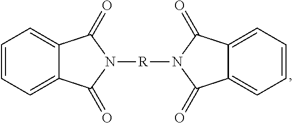

and
less than 200 parts per million of a total of the 3,3′-bis(halophthalimide), the 4,3′-bis(halophthalimide), the 4,4′-bis(halophthalimide), and the halo(bisphthalimide), wherein X is a halogen.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A polymer composition comprising a polyetherimide having the formula 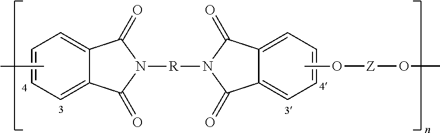
wherein
n is greater than 1,
each R is para-phenylene,
each Z is the same or different, and is an aromatic C₆₋₂₄ monocyclic or polycyclic moiety optionally substituted with 1 to 6 C₁₋₁₈ alkyl groups, 1 to 8 halogen atoms, or a combination thereof, and
the divalent bonds between the —O—Z—O— group and the phenyl substituents are in the 3,3′, 3,4′, 4,3′, and 4,4′ positions, the divalent bonds of the of the —O—Z—O— group being made from a bis(halophthalimide) composition comprising, based on the weight of the bis(halophthalimide) composition,
at least 15 wt. % of a 3,3′-bis(halophthalimide) of the formula 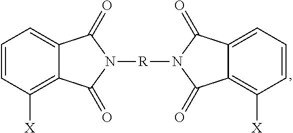
from more than 17 wt. % to less than 85 wt. % of a 3,4′-bis(halophthalimide) of the formula 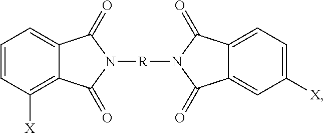
and
from more than 0 wt. % to less than 27 wt. % of a 4,4′-bis(halophthalimide) of the formula 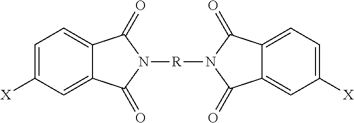
wherein each X is independently fluoro, chloro, bromo, or iodo, and R is para-phenylene; and
wherein
the T_{g} of the polyetherimide is 230° to 253° C.; the polyetherimide retains 20% to 40% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition, each determined by parallel plate rheometry over at a temperature ranging from 30° to 110° C.; and
the polyetherimide has at least a 30% lower shear rate viscosity than of the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition.

2. The composition of claim 1, wherein the bis(halophthalimide) composition comprises, based on the weight of the bis(halophthalimide) composition, from more than 45 wt. % to less than 75 wt. % of the 4,3′-bis(halophthalimide), wherein
the composition comprises less than 1 wt. % of total cyclics (n=1, 2, and 3) based on the total weight of the polyetherimide; and
the composition has a greater chemical resistance to a halogenated solvent than the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition.

3. The composition of claim 2, wherein the halogenated solvent is dichloromethane.

4. The composition of claim 1, wherein the bis(halophthalimide) composition comprises, based on the weight of the bis(halophthalimide) composition, from more than 0 wt. % to less than 15 wt. % of the 4,4′-bis(halophthalimide), wherein:
the T_{g} of the polyetherimide is at least 30° C. higher than the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition;
the polyetherimide retains at least 40% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition; and
the polyetherimide has at least a 30% lower shear rate viscosity than for the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition, and each determined by parallel plate rheometry over at a temperature ranging from 30° to 110° C.; and wherein each X is independently fluoro, chloro, bromo, or iodo, and R is para-phenylene.

5. The composition of claim 1, wherein the bis(halophthalimide) composition comprises, based on the weight of the bis(halophthalimide) composition, from more than 48 wt. % to less than 75 wt. % of the 4,3′-bis(halophthalimide), and less than 26 wt. % of the 4,4′-bis(halophthalimide), wherein
the composition comprises less than 1 wt. % of total cyclics (n=1, 2, and 3) based on the total weight of the polyetherimide; and
the polyetherimide retains at least 20% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 26 wt. % of 1,3-bis[N-(4-chlorophthalimido)]benzene, each based on the weight of the 1,3-bis[N-(halophthalimido)]benzene composition; and
the polyetherimide has at least a 30% lower shear rate viscosity than for the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 26 wt. % of 1,3-bis[N-(4-chlorophthalimido)]benzene, each based on the weight of the 1,3-bis[N-(halophthalimido)]benzene composition.

6. The composition of claim 1, wherein the bis(halophthalimide) composition comprises
from more than 30 wt. % to less than 85 wt. % of the 3,3′-bis(halophthalimide),
from more than 48 wt. % to less than 75 wt. % of the 4,3′-bis(halophthalimide), and
from more than 0 wt. % to less than 15 wt. % of the 4,4′-bis(halophthalimide).

7. The composition of claim 1, wherein Z is 2,2-(4-phenylene)isopropylidene and the halo group is chloro.

8. The composition of claim 1, further comprising an additive selected from impact modifiers, fillers, reinforcing agents, anti-oxidants, heat stabilizers, light stabilizers, ultraviolet light absorbers, plasticizers, lubricants, mold release agents, antistatic agents, colorants, blowing agents, flame retardants, anti-drip agents, and radiation stabilizers, and a combination thereof.

9. The composition of claim 1, further comprising an additive selected from an antioxidant, an ultraviolet light absorber, a mold release agent, and a combination thereof.

10. The composition of claim 1, wherein the polyetherimide comprises, based on parts of the polyetherimide,
less than 100 parts per million each of the 3,3′-bis(halophthalimide), the 4,3′-bis(halophthalimide), and the 4,4′-bis(halophthalimide),
less than 100 parts per million of a halo(bisphthalimide) of the formula 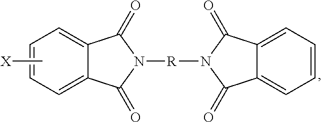
less than 100 parts per million of a bisphthalimide of the formula 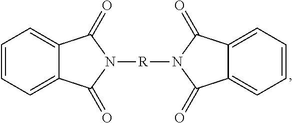
and
less than 200 parts per million of a total of the 3,3′-bis(halophthalimide), the 4,3′-bis(halophthalimide), the 4,4′-bis(halophthalimide), and the halo(bisphthalimide).

11. An article comprising the composition of claim 1.

12. The article of claim 11, selected from a sheet, film, multilayer sheet, multilayer film, molded part, extruded profile, coated part, and fiber.

13. The article of claim 12, wherein the article is a molded part having a thickness from 1 to 5 millimeters.

14. The article of claim 11, selected from a camera module, an antenna module, an electrical connector, a hard disc drive bracket, a laptop cover, and a BiTs socket.

15. A method of forming an article, comprising shaping, extruding, blow molding, or molding the composition of claim 1 to form the article.

16. The method of claim 15, comprising molding the composition to form an article having a thickness from 1 to 5 millimeters.

17. The method of claim 16, wherein the article is selected from a camera module, an antenna module, an electrical connector, a hard disc drive bracket, a laptop cover, and a BiTs socket.

18. A method for the manufacture of polyetherimide composition, comprising
reacting an alkali metal salt of a dihydroxy aromatic compound of the formula
MO—Z—OM
wherein M is an alkali metal and Z is an aromatic C₆₋₂₄ monocyclic or polycyclic moiety optionally substituted with 1 to 6 C₁₋₈ alkyl groups, 1 to 8 halogen atoms, or a combination thereof, with
a bis(halophthalimide) composition comprising, based on the weight of the bis(halophthalimide) composition,
from more than 30 wt. % to less than 85 wt. % of a 3,3′-bis(halophthalimide) of the formula 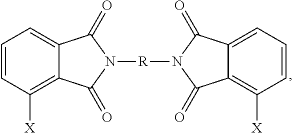
from more than 17 wt. % to less than 85 wt. % of a 4,3′-bis(halophthalimide) of the formula 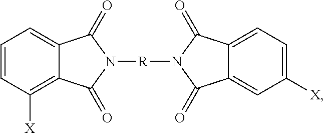
and
from more than 0 wt. % to less than 27 wt. % of a 4,4′-bis(halophthalimide) of the formula 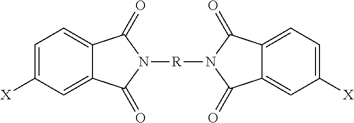
wherein
each R is para-phenylene and
each X is independently fluoro, chloro, bromo, or iodo, and
further wherein
the polyetherimide is of the formula 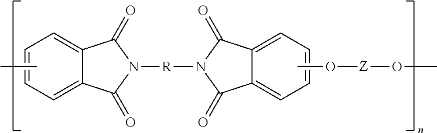
wherein n is greater than 1, each R is para-phenylene, each Z is the same or different, and are as defined above, and the divalent bonds between the —O—Z—O— group and the phenyl substituents are in the 3,3′, 3,4′, 4,3′, and 4,4′ positions;
the T_{g} of the polyetherimide is 230° to 253° C.:
the polyetherimide retains 20% to 40% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition, each determined by parallel plate rheometry at a temperature ranging from 30° to 110° C.; and
the polyetherimide has at least a 30% lower shear rate viscosity than for the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition.

19. The method of claim 18, wherein the bis(halophthalimide) composition comprises, based on the weight of the bis(halophthalimide) composition, from more than 45 wt. % to less than 75 wt. % of the 4,3′-bis(halophthalimide), wherein
the composition comprises less than 1 wt. % of total cyclics (n=1, 2, and 3) based on the total weight of the polyetherimide; and
the composition has a greater chemical resistance to a halogenated solvent than the same polyetherimide except made from a 1,3-bis[N-(halophthalimido)]benzene composition comprising less than 10 wt. % of 1,3-[N-(4-chlorophthalimido)][N-(3-chlorophthalimido)]benzene based on the weight of the 1,3-bis[N-(halophthalimido)]benzene composition.

20. The method of claim 19, wherein the halogenated solvent is dichloromethane.

21. The method of claim 18, wherein the bis(halophthalimide) composition comprises, based on the weight of the bis(halophthalimide) composition, from more than 0 wt. % to less than 15 wt. % of the 4,4′-bis(halophthalimide, wherein
the T_{g} of the polyetherimide is at least 30° C. higher than the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition;
the polyetherimide retains at least 40% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition; and
the polyetherimide has at least a 30% low shear rate viscosity than for the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition, and each determined by parallel plate rheometry over at a temperature ranging from 30° to 110° C.; and wherein each X is independently fluoro, chloro, bromo, or iodo, and R is para-phenylene.

22. The method of claim 18, wherein the bis(halophthalimide) composition comprises, based on the weight of the bis(halophthalimide) composition, from more than 48 wt. % to less than 75 wt. % of the 4,3′-bis(halophthalimide), and less than 26 wt. % of the 4,4′-bis(halophthalimide), wherein
the composition comprises less than 1 wt. % of total cyclics (n=1, 2, and 3) based on the total weight of the polyetherimide; and
the polyetherimide retains at least 20% higher stiffness than the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 26 wt. % of 1,3-bis[N-(4-chlorophthalimido)]benzene, each based on the weight of the 1,3-bis[N-(halophthalimido)]benzene composition; and
the polyetherimide has a 30% low shear rate viscosity than for the same polyetherimide except made from a 1,3-bis[N-(halophthalimido)]benzene composition comprising less than 10 wt. % of 1,3-[N-(4-chlorophthalimido)][N-(3-chlorophthalimido)]benzene and more than 15 wt. % of 1,3-bis[N-(4-chlorophthalimido)]benzene, each based on the weight of the 1,3-bis[N-(halophthalimido)]benzene composition.

23. The method of claim 18, wherein the bis(halophthalimide) composition comprises
from more than 30 wt. % to less than 85 wt. % of the 3,3′-bis(halophthalimide),
from more than 48 wt. % to less than 75 wt. % of the 4,3′-bis(halophthalimide), and
from more than 0 wt. % to less than 15 wt. % of the 4,4′-bis(halophthalimide).

24. The method of claim 18, wherein Z is 2,2-(4-phenylene)isopropylidene and the halo group is chloro.

25. The method of claim 18, further comprising adding an additive to the composition, wherein the additive is selected from impact modifiers, fillers, reinforcing agents, anti-oxidants, heat stabilizers, light stabilizers, ultraviolet light absorbers, plasticizers, lubricants, mold release agents, antistatic agents, colorants, blowing agents, flame retardants, anti-drip agents, and radiation stabilizers, and a combination thereof.

26. The method of claim 18, further comprising adding an additive to the composition, wherein the additive is selected from an antioxidant, an ultraviolet light absorber, a mold release agent, and a combination thereof.

27. The method of claim 18, wherein the polyetherimide comprises, based on parts of the polyetherimide,
less than 100 parts per million each of the 3,3′-bis(halophthalimide), the 4,3′-bis(halophthalimide), and the 4,4′-bis(halophthalimide),
less than 100 parts per million of a halo(bisphthalimide) of the formula 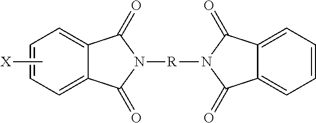
less than 100 parts per million of a bisphthalimide of the formula 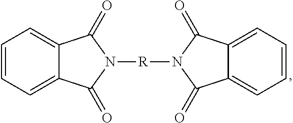
and
less than 200 parts per million of a total of the 3,3′-bis(halophthalimide), the 4,3′-bis(halophthalimide), the 4,4′-bis(halophthalimide), and the halo(bisphthalimide), wherein X is a halogen.
